(19) United States
(12) Patent Application Publication
(10) Pub. No.: US 2022/0018363 A1
(43) Pub. Date: Jan. 20, 2022

(54) FAN SILENCING SYSTEM

(71) Applicant: FUJIFILM Corporation, Tokyo (JP)

(72) Inventors: Shinya HAKUTA, Ashigarakami-gun (JP); Akihiko OHTSU, Ashigarakami-gun (JP); Shogo YAMAZOE, Ashigarakami-gun (JP)

(73) Assignee: FUJIFILM Corporation, Tokyo (JP)

(21) Appl. No.: 17/488,853

(22) Filed: Sep. 29, 2021

Related U.S. Application Data
(63) Continuation of application No. PCT/JP2020/013040, filed on Mar. 24, 2020.

(30) Foreign Application Priority Data
Apr. 24, 2019 (JP) 2019-082635

(51) Int. Cl. F04D 29/66; G10K 11/172; G10K 11/162; F04D 29/52

(52) U.S. Cl. CPC F04D 29/665; F04D 29/522; G10K 11/162; G10K 11/172

(57) ABSTRACT

A fan silencing system includes a fan, and an acoustic resonance structure, in which the acoustic resonance structure is disposed in a near field region of a sound generated by the fan.

### CROSS-REFERENCE TO RELATED APPLICATIONS

This application is a Continuation of PCT International Application No. PCT/JP2020/013040 filed on Mar. 24, 2020, which claims priority under 35 U.S.C § 119(a) to Japanese Patent Application No. 2019-082635 filed on Apr. 24, 2019. Each of the above application(s) is hereby expressly incorporated by reference, in its entirety, into the present application.

### BACKGROUND OF THE INVENTION

### 1. Field of the Invention

The present invention relates to a fan silencing system.

### 2. Description of the Related Art

A fan is known to generate a strong sound in a very narrow band at a frequency corresponding to the number of blades and a rotation speed thereof, which has a problem as noise. In order to reduce such a noise, it is proposed to dispose a silencer in a passage of an air flow (wind) generated by the fan.

For example, JP2001-142148A discloses a silencing device for a device comprising a heat source such as a light source lamp unit, and an exhaust fan for exhausting heat from the heat source, in which an air guide member of exhaust air of the exhaust fan is hermetically disposed from an air outflow side of the exhaust fan to the outside of the device, an elastic film body that can vibrate with a sound wave generated by the exhaust fan is disposed on a peripheral wall portion of the air guide member facing a ventilation passage at a position in which the elastic film body at least collides with a flow of the exhaust air and does not block a flow of the air in the exhaust direction, an air chamber is formed on a rear side of the elastic film body. The silencing device disclosed in JP2001-142148A silences a sound by converting sound energy into vibration energy by applying an air flow (wind) generated by the fan to the elastic film body to vibrate the elastic film body.

In addition, in order to reduce noise in a narrow band, it is proposed to use a resonance type silencer.

For example, JP2008-036065A discloses an electric blower comprising an impeller having a plurality of blades, an air guide having a plurality of stationary blades disposed around the impeller, an electric motor that drives a rotation shaft to which the impeller is fixed, a substantially cylindrical fan case having an intake port that allows an air flow into the impeller in the center and an exhaust port on a side surface, and fixed to the electric motor in a state of encompassing the impeller and the air guide, a soundproof cylinder having an exhaust port and airtightly fixed to the fan case in a state of encompassing the entire electric motor, a substantially cylindrical silencing unit including a recess portion having a predetermined width and depth on the circumference and provided at a predetermined position on a surface of the electric motor, and a thin film portion having flexibility, which is provided an opening end surface of the recess portion of the silencing unit. JP2008-036065A discloses that a sound having a specific frequency determined by the depth of the recess portion is resonated to silence the sound.

### SUMMARY OF THE INVENTION

As in JP2001-142148A, in a case of a configuration in which the sound is silenced by applying the air flow (wind) generated by the fan to vibrate the elastic film body, it is necessary to dispose the elastic film body such that the wind directly hits the elastic film body in order to vibrate strongly, and thus the elastic film body is disposed to block a part of an air duct of the air flow generated by the fan. Therefore, there is a problem that a large pressure loss of the fan is caused and an air volume is reduced.

In addition, in JP2001-142148A, since a large wind pressure is applied to the elastic film body, a characteristic of the elastic film body is changed in a case in which the air volume and the wind pressure of the fan are changed. Therefore, the characteristic of the elastic film body and a resonance effect formed by a back air layer cannot be used. Therefore, since it is not possible to obtain a large silencing effect aiming at the sound of a specific frequency generated by the rotation of the fan, it is difficult to obtain a large silencing effect on the fan.

It is known that fan noises are generated discretely at a plurality of frequencies in response to the number of blades and a rotation speed thereof. A resonance type silencer as in JP2008-036065A silences a sound having a single frequency that coincides with the resonance frequency of the resonance type silencer, and has a low silencing effect on sounds in other frequency bands. Therefore, there is a problem that it is difficult to silence the sounds of the plurality of frequencies generated discretely.

An object of present invention is to solve the above-described problems in the related art, and to provide a fan silencing system that can silence a sound in a narrow band of a plurality of discrete frequencies generated by a fan while ensuring an air volume of the fan.

The present invention solves the problem by following configurations.

[1] A fan silencing system comprising a fan, and an acoustic resonance structure, in which the acoustic resonance structure is disposed in a near field region of a sound generated by the fan.

[2] The fan silencing system according to [1], in which a resonance frequency of the acoustic resonance structure coincides with at least one frequency of discrete frequency sounds caused by a rotation of a blade of the fan.

[3] The fan silencing system according to [1] or [2], in which, as viewed from a direction perpendicular to a blowing port of the fan, an area in which the acoustic resonance structure overlaps with the blowing port is 50% or less of an area of the blowing port.

[4] The fan silencing system according to any one of [1] to [3], in which the acoustic resonance structure constitutes a part of a wall surface of a ventilation passage connected to the fan.

[5] The fan silencing system according to any one of [1] to [4], in which a surface provided with a vibrating body of the acoustic resonance structure is disposed in parallel to an axis perpendicular to a blowing port of the fan.

[6] The fan silencing system according to any one of [1] to [5], further comprising a windbreak member that transmits a sound to a surface side provided with a vibrating body of the acoustic resonance structure.

[7] The fan silencing system according to any one of [1] to [6], in which the acoustic resonance structure is in contact with the fan.

[8] The fan silencing system according to [7], in which the acoustic resonance structure is in contact with the fan via an anti-vibration member.

[9] The fan silencing system according to any one of [1] to [8], in which a plurality of the acoustic resonance structures having different resonance frequencies are provided, and the acoustic resonance structure having a high resonance frequency is disposed at a position closer to the fan than the acoustic resonance structure having a low resonance frequency.

[10] The fan silencing system according to any one of [1] to [9], in which the acoustic resonance structure is disposed only on a downstream side of the fan in a blowing direction of the fan.

[11] The fan silencing system according to any one of [1] to [9], in which the acoustic resonance structure is disposed on an upstream side and a downstream side of the fan in a blowing direction of the fan.

[12] The fan silencing system according to any one of [1] to [11], in which the acoustic resonance structure is a film type resonance structure including a film having a fixed peripheral portion and supported to allow a film vibration, and a back space formed on one surface side of the film.

[13] The fan silencing system according to [12], in which the film type resonance structure has a through-hole that communicates the back space with an outside.

[14] The fan silencing system according to any one of [1] to [13], in which the fan is an axial fan.

According to the present invention, it is possible to provide a fan silencing system that can silence a sound in a narrow band of a plurality of discrete frequencies generated by a fan while ensuring an air volume of the fan.

### BRIEF DESCRIPTION OF THE DRAWINGS

FIG. 1 is a perspective view schematically showing an example of a fan silencing system according to an embodiment of the present invention.

FIG. 2 is a view of the fan silencing system of FIG. 1 as viewed from an A direction.

FIG. 3 is a cross-sectional view of FIG. 2.

FIG. 4 is a cross-sectional view schematically showing another example of the fan silencing system according to the embodiment of the present invention.

FIG. 5 is a cross-sectional view schematically showing still another example of the fan silencing system according to the embodiment of the present invention.

FIG. 6 is a cross-sectional view schematically showing still another example of the fan silencing system according to the embodiment of the present invention.

FIG. 7 is a cross-sectional view schematically showing still another example of the fan silencing system according to the embodiment of the present invention.

FIG. 8 is a cross-sectional view schematically showing still another example of the fan silencing system according to the embodiment of the present invention.

FIG. 9 is a cross-sectional view schematically showing still another example of the fan silencing system according to the embodiment of the present invention.

FIG. 10 is a cross-sectional view schematically showing still another example of the fan silencing system according to the embodiment of the present invention.

FIG. 11 is a cross-sectional view schematically showing still another example of the fan silencing system according to the embodiment of the present invention.

FIG. 12 is a cross-sectional view schematically showing still another example of the fan silencing system according to the embodiment of the present invention.

FIG. 13 is a view schematically showing a configuration of Comparative Example 1.

FIG. 14 is a graph showing a relationship between a frequency and measurement sound volume.

FIG. 15 is a graph showing a relationship between the frequency and the measurement sound volume.

FIG. 16 is a graph showing a relationship between the frequency and the measurement sound volume.

FIG. 17 is a view schematically showing a configuration of Comparative Example 2.

FIG. 18 is a graph showing a relationship between the frequency and a silencing volume.

FIG. 19 is a graph showing a relationship between the frequency and the measurement sound volume.

FIG. 20 is a graph showing a relationship between the frequency and the measurement sound volume.

FIG. 21 is a graph showing a relationship between the frequency and the measurement sound volume.

FIG. 22 is a graph showing a relationship between the frequency and the measurement sound volume.

FIG. 23 is a graph showing a relationship between the frequency and the silencing volume.

FIG. 24 is a graph showing a relationship between the frequency and the measurement sound volume.

FIG. 25 is a graph showing a relationship between a current and a wind speed.

FIG. 26 is a view schematically showing a configuration of Example 5.

FIG. 27 is a graph showing a relationship between the frequency and the measurement sound volume.

FIG. 28 is a graph showing a relationship between the frequency and the measurement sound volume.

FIG. 29 is a graph showing a relationship between the frequency and the measurement sound volume.

FIG. 30 is a graph showing a relationship between the frequency and the measurement sound volume.

FIG. 31 is a view schematically showing a configuration of Comparative Example 7.

FIG. 32 is a view schematically showing a configuration of Example 9.

FIG. 33 is a graph showing a relationship between the frequency and the measurement sound volume.

### DESCRIPTION OF THE PREFERRED EMBODIMENTS

The present invention will be described below in detail.

The description of configuration elements described below is based on a representative embodiment of the present invention, but the present invention is not limited to such an embodiment.

Note that in the present specification, the numerical range represented by “to” means a range including numerical values denoted before and after “to” as a lower limit value and an upper limit value.

In addition, in the present specification, “orthogonal”, “parallel”, and “perpendicular” include a range of errors accepted in the technical field to which the present invention belongs. For example, “orthogonal” means that it is within a range of less than ±10° with respect to exact orthogonality, and an error with respect to the exact orthogonality is preferably 3° or less. In addition, as for an angle, “parallel” means that it is within a range of less than ±10° with respect to an exact angle.

In the present specification, “the same” and “coincide” includes the error range generally accepted in the technical field.

[Fan Silencing System]

A fan silencing system according to an embodiment of the present invention includes a fan, and an acoustic resonance structure, in which the acoustic resonance structure is disposed in a near field region of a sound generated by the fan.

The near field region of the sound generated by the fan is a region in which a sound wave is in a near field state. The state in which the sound wave is in the near field is as described below.

A propagation direction and an intensity of each sound wave generated from a sound source is determined by a difference of attenuation for each wave number of the wave or space limitation (duct wall, bending of a flow passage, and the like). However, the sound wave generated from the sound source is not under a control of an influence by the attenuation and limitation described above immediately after the sound wave is generated, and has an amplitude over a wide wave number range including a high wave number component that cannot be propagated to a long distance. The sound wave is propagated over a certain distance or longer, and then becomes a plane wave, and the directionality is determined. The state immediately after the sound wave is generated from the sound source is referred to as a “near field” state. Therefore, a region in the vicinity of the sound source that satisfies the conditions described above is defined as the near field region.

It is known, as the wave theory, that in a case of propagation about λ/4 in this region, the wave number component, which cannot be propagated to a long distance, cannot be propagated.

Therefore, the fan, which is the sound source in the embodiment of the present invention, generates the sound from a blade portion of the fan, and thus a region at a distance of less than λ/4 from the blade portion of the fan is the near field region. Note that in a case in which the fan is disposed in the flow passage, a region in which a distance from the fan along the flow passage is less than λ/4 is the near field region.

The sound in the near field state (hereinafter, also referred to as a near field sound) among the sounds emitted from the sound source is present to spatially surround the sound source, which includes a sound which has a higher wave number than a wave number of a propagation sound wave (wave number satisfying a wave number k>2π×f/c in a case in which a sound speed is defined as c and a frequency is defined as f). Specifically, in a wave equation followed by acoustic propagation, a wave amplitude of a sound component having a high wave number of k>2π×f/c is exponentially attenuated with respect to the distance, and thus it cannot be propagated farther than the sound source. However, in the near field region, an influence of the attenuation is small, such a sound having a high wave number is combined with the sound source and localized, as the near field sound, only around the sound source.

It is considered that in the fan silencing system according to the embodiment of the present invention, by disposing the acoustic resonance structure in the near field region, the following two interactions occur with respect to the near field sound in the near field region to obtain a silencing effect.

A first mechanism of the interaction is as described below.

The sound wave having a high wave number of the near field sound has a small spatial wave size (reciprocal of the wave number). Therefore, it is possible to spatially and locally interact with the acoustic resonance structure disposed in the vicinity of the sound source. Specifically, a sound pressure is locally applied to only a small part of the acoustic resonance structure. By causing such a local interaction, which is difficult with the sound wave having a wave number propagated to a long distance, in the acoustic resonance structure a nonlinear effect is likely to occur in the acoustic resonance structure. As for the first mechanism of the interaction, it is presumed that due to the nonlinear effect, the silencing effect also acts on the sound at a frequency other than a target silencing frequency (resonance frequency) of the acoustic resonance structure.

As for a second mechanism of the interaction, it is presumed that an effect of suppressing generation of the sound waves from the sound source by the sound reflected by the acoustic resonance structure and returning to a sound source position.

In a case in which the fan is rotated, the blade cuts the air, and a minute fluid vortex is generated in the air around the blade. A sound is generated by the deformation of this vortex at an edge portion of the blade, which is a mechanism of generating a sound (aerodynamic sound) by the fan. By disposing the acoustic resonance structure in the vicinity of the sound source, the sound generated from the sound source is reflected by the acoustic resonance structure, and the reflected sound is propagated to the sound source and interferes with the sound generated from the sound source. As a result of the interference, the sound pressure at the sound source position is reduced.

As an effect at this time, first, the sound pressure at the sound source position is reduced, so that an emission amount of the sound from the sound source is reduced. As a result, emission sound volume is greatly reduced.

Further, there is a high possibility that the generation of the sound source itself, in the fan, the generation of the minute vortex itself can be suppressed in addition to a process of generating the sound from the sound source. In the acoustic resonance structure disposed in the near field region, the interaction is made with the near field sound having a high wave number and staying in the vicinity of the sound source in addition to the sound wave emitted and propagated from the sound source to a long distance. By strong interaction with the acoustic resonance structure and the near field sound, a wave number mode of the sound emitted from an acoustic vortex is biased toward the near field sound, which is a sound not propagated to a long distance, the sound pressure at the sound source position is smaller in the near field by the reflection due to the interaction, and a generation amount of the minute vortex, which is the sound source, is extremely strongly suppressed.

On the other hand, in the acoustic resonance structure disposed in a distant field, the sound pressure at the sound source position is not reduced at the near field wave number, so that the generation of the minute vortex itself, which is the sound source, cannot be suppressed so much. Therefore, in a case in which the acoustic resonance structure is disposed in the near field region that can cover the wave number of the sound wave from a low wave number to the wave number of the near field sound, the generation amount of the minute vortex, which is the sound source, is extremely small.

By reducing the generation amount of the minute vortex, which is the sound source, it is possible to reduce the aerodynamic sounds of other frequencies, in addition to the frequency of the acoustic resonance structure. In particular, since phases of the sounds emitted from the minute vortices from the blades are aligned, a peak sound of the fan emits a strong sound by causing a strong interference effect. At this time, since the energy is proportional to the square of the number of the sound sources, in a case in which the number of minute vortices, which are the sound sources, is reduced, the energy of the emitted sound is reduced in response to the square. Therefore, it is likely to be affected by a sound reduction effect in a case in which the generation amount of minute vortex is reduced. Therefore, the silencing effect selectively appears for a plurality of the peak sounds. It is considered that a suppression effect of a plurality of the discrete frequency sounds in the embodiment of the present invention is mainly contributed by the reduction in the number of the sound sources by the second mechanism and the accompanying suppression effect of the peak sound.

Note that it is considered that a noise called a broadband noise (turbulent noise) other than the peak sound of the fan is generated after the phases of the sound sources of the blades are disordered and intensification and cancellation occur, and thus a noise volume is not reduced so much even in a case in which the number of the sound sources is reduced, and as a result, only the peak sound is selectively suppressed.

In the field of optics, for example, J R Lakowicz et. al., “Radiative Decay Engineering: 2. Effects of Silver Island Films on Fluorescence Intensity, Lifetimes, and Resonance Energy Transfer” Analytical Biochemistry, 301, 261-277 (2002) shows such an effect for a distance between a metal particle and a fluorescent particle, a luminescence intensity, the life of the light source, or a generation rate. It is considered that the same effect occurs to the sound wave and the sound source.

When the acoustic resonance structure is in the near field region, the distance from the sound source is less than λ/4 at the maximum, and thus a phase change of the sound wave due to the propagation is small. On the other hand, the phase of the sound wave is inverted (phase change of π) due to the reflection by the acoustic resonance structure. Therefore, since a phase deviation is substantially in a phase inversion state, the sound generated from the sound source and the sound reflected by the acoustic resonance structure and returned to the sound source interfere with each other in opposite phases. Therefore, the two sounds cancel each other out at the sound source position, and the silencing effect occurs at the sound source position.

As described above, in the fan silencing system according to the embodiment of the present invention, due to the mechanism by which the spatially localized sound peculiar to the near field sound causes the nonlinear effect due to the local interaction by disposing the acoustic resonance structure in the near field region and the mechanism by which the generation of the fluid vortex, which is the sound source, is suppressed by reducing the sound pressure at the sound source position, the silencing effect in a wide frequency band can be obtained regardless of the resonance frequency of the acoustic resonance structure. Therefore, the silencing effect can be obtained for the sound of a plurality of discrete frequencies generated by the fan (hereinafter, also referred to as a discrete frequency sound).

In addition, the two mechanisms of the interactions described above are an effect due to the interaction between the sound source (sound wave) and the acoustic resonance structure due to the disposition of the acoustic resonance structure in the near field region. Therefore, since a flow of the wind is irrelevant, it is not necessary to dispose the acoustic resonance structure such that the wind directly hits the acoustic resonance structure. That is, it is not necessary to dispose the acoustic resonance structure to partially block the air duct of the air flow generated by the fan. Therefore, it is possible to silence the sound generated by the fan while ensuring the air volume of the fan.

Here, as described above, the region in which the distance from the sound source is less than λ/4 is the near field region. Therefore, a size of the near field region differs depending on a wavelength (frequency) of the sound wave.

In the present invention, in a case in which a resonance frequency fr of the acoustic resonance structure (in a case in which there are a plurality of resonances, the lowest order thereof) is set, a wavelength thereof is λ, and a region less than λ/4 from a sound source portion of the fan is defined as the near field region.

Note that at least a part of the acoustic resonance structure is preferably disposed in a region at a distance of λ/6 from the fan (sound source), and is more preferably disposed in a region at a distance of λ/8 from a viewpoint of further improving the silencing effect. As the distance between the sound source and the acoustic resonance structure is shorter, the phase change in a process in which the sound is reflected from the acoustic resonance structure and returned to the sound source is reduced in the second mechanism described above, and thus the silencing effect due to the interference between the reflected sound and the sound from the sound source is further improved.

In the present invention, the acoustic resonance structure resonates with the sound wave at the resonance frequency thereof to cause the silencing effect. Various structures can be selected as long as the structure causes a resonance phenomenon, for example, representative examples of the acoustic resonance structure include a film type resonance structure, a Helmholtz resonance structure, and an air column resonance structure. Each acoustic resonance structure will be described below in detail.

A configuration of the fan silencing system according to the embodiment of the present invention will be described with reference to the drawings.

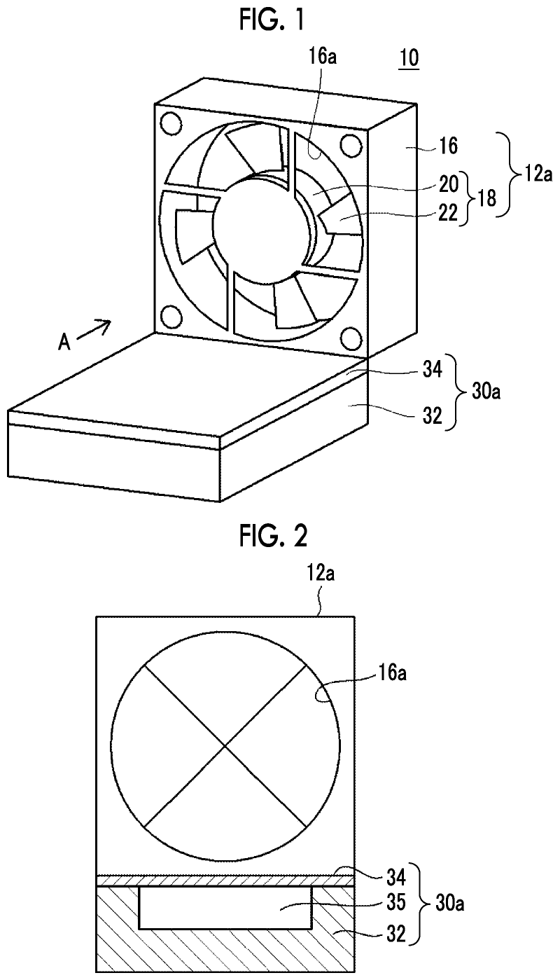

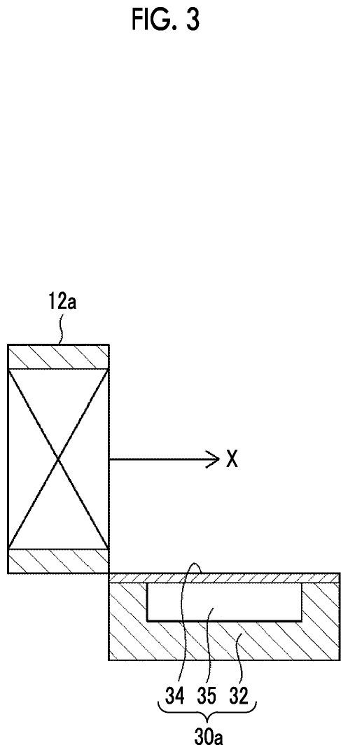

FIG. 1 is a perspective view schematically showing an example of the fan silencing system according to a preferred embodiment of the present invention. FIG. 2 is a front view of FIG. 1 as viewed from an A direction. FIG. 3 is a cross-sectional view of FIG. 2. Note that in FIG. 2, the acoustic resonance structure is shown in cross section. Note that in FIGS. 2 and 3, a rotor of the fan and the like are not shown, and only an outer shape thereof and a blowing port are shown.

A fan silencing system 10 shown in FIGS. 1 to 3 includes an axial fan 12a and a film type resonance structure 30a.

The axial fan 12a is basically a known axial fan, and rotates a rotor having a plurality of blades to impart kinetic energy to a gas to blow the gas in an axial direction.

Specifically, the axial fan 12a includes the casing 16, the motor (not shown) attached to the casing 16, and a rotor 18 comprising a shaft portion 20 attached to the motor and rotated, and a blade 22 formed to protrude to an outer side of the shaft portion 20 in a radial direction.

Note that in the following description, a rotation axis of the shaft portion 20 (rotor 18) is simply referred to as the “rotation axis”, and the radial direction from the shaft portion 20 (rotor 18) is simply referred to as the “radial direction”.

The motor is a general electric motor which rotates the rotor 18.

The shaft portion 20 of the rotor 18 has a substantially columnar shape, and one bottom surface side thereof is attached to a rotation shaft of the motor, and the rotor 18 is rotated by the motor.

The blade 22 is formed on a peripheral surface of the shaft portion 20 to protrude an outer side of the peripheral surface in the radial direction. In addition, the rotor 18 has a plurality of the blades 22, and the plurality of blades 22 are arranged in a circumferential direction of the peripheral surface of the shaft portion 20. In the example shown in FIG. 1, the rotor 18 has a configuration having four blades 22, but the present invention is not limited thereto, and the rotor 18 need only have the plurality of blades 22. In addition, the number of frames of the casing 16 is four in the drawing, but the present invention is not limited thereto.

In addition, a shape of the blade 22 can be various shapes used in a known axial fan in the related art.

In the axial fan 12a, the rotor 18 having the blade 22 is rotated by the motor to generate an air flow (wind) in the rotation axis direction. A flow direction of the air flow is not limited, and may flow, in the rotation axis direction, from the motor side to a direction opposite to the motor, or may flow from a side opposite to the motor to the motor side.

In addition, the casing 16 fixes the motor, and surrounds the rotor 18 (blade 22) that can be rotated in the radial direction.

The thickness of the casing 16 in the rotation axis direction is thicker than the thicknesses of the blade 22 and the shaft portion 20 such that the rotor 18 can be protected from the outside.

The casing 16 has a blowing port 16a open in the rotation axis direction, and the rotor 18 is disposed in the blowing port 16a. In a case in which the rotor 18 having the blade 22 is rotated, air is taken in from one opening surface side of the blowing port 16a and the air is supplied from the other opening surface side. That is, the air flow (wind) generated by the rotation of the rotor 18 is supplied in the rotation axis direction.

A thickness of the casing 16 need only be a thickness that can protect the rotor 18 from the outside, suppress the air flow in the radial direction among the air flows generated by the rotation of the rotor 18, and increase the air volume in the rotation axis direction, that is, need only be a thickness about 1.01 times to 3.00 times the thickness of the blade 22 and/or the shaft portion 20.

Further, the axial fan 12a may have various configurations of a known axial fan.

For example, in the example shown in FIG. 1, the axial fan 12a has a hole into which a fastening member such as a screw is inserted in a case in which the axial fan 12a is fixed to various devices.

The film type resonance structure 30a silences the discrete frequency sound generated by the axial fan 12a.

The film type resonance structure 30a has a frame 32 and a film 34, has a configuration in which a back space 35 surrounded by the frame 32 and the film 34 is formed, and resonates by the film 34 supported by the frame 32 to allow the film vibration.

In the examples shown in FIGS. 1 to 3, the frame 32 has a rectangular parallelepiped shape an opening portion having a bottom surface formed on one surface. That is, the frame 32 has a bottomed quadrangular pillar shape with one surface open.

The film 34 is a film-like member, and covers an opening surface of the frame 32 on which the opening portion is formed, and a peripheral portion thereof is fixed to the frame 32 and is supported to allow vibration thereof.

In addition, the back space 35 surrounded by the frame 32 and the film 34 is formed on a back side (frame 32 side) of the film 34. In the examples shown in FIGS. 1 to 3, the back space is a closed space, which is closed.

In the examples shown in FIGS. 1 to 3, the film type resonance structure 30a is disposed on a downstream side of the axial fan 12a in a blowing direction. In addition, the film type resonance structure 30a is disposed at a position in which blowing by the axial fan 12a (blowing port 16a) is not blocked, specifically, around a region serving as an air duct for the wind blown by the axial fan 12a. In addition, in the film type resonance structure 30a, the film 34 is disposed in parallel to the rotation axis direction (X direction in FIG. 3) of the axial fan 12a, and the film 34 is disposed to face the rotation axis side.

Here, in the related art, in a case in which the acoustic resonance structure such as the film type resonance structure is used for silencing, the resonance frequency of the acoustic resonance structure is allowed to coincide with the frequency of the sound to be silenced, and the resonance phenomenon is used to silence the sound of this frequency. Therefore, there is a problem that the silencing effect is low for the sounds of other frequency bands, and it is difficult to silence the plurality of discrete frequency sounds.

On the other hand, in the fan silencing system according to the embodiment of the present invention, by disposing the film type resonance structure 30a in the near field region of the sound generated by the fan, the two mechanisms of the interaction described above occur, so that the plurality of discrete frequency sounds generated by the axial fan 12a can be silenced.

At this time, it is necessary that at least a part of a vibrable portion of the film 34 is present in the near field region, and more desirably, it is necessary that a centroid position of the vibrable portion of the film 34 is present in the near field region.

Here, in the fan silencing system according to the embodiment of the present invention, the resonance frequency of the film type resonance structure 30a (acoustic resonance structure) is not particularly limited.

In addition, in order to effectively utilize the silencing effect due to the original resonance of the acoustic resonance structure, the resonance frequency of the acoustic resonance structure is desirably in an audible range (20 Hz to 20000 Hz), and more desirably in a range of 100 Hz to 16000 Hz.

It is preferable that the resonance frequency of the film type resonance structure 30a (acoustic resonance structure) coincide with at least one frequency of the discrete frequency sounds caused by the rotation of the blade of the fan. As a result, among the discrete frequency sounds, the silencing effect at the frequency coinciding with the resonance frequency of the acoustic resonance structure can be further improved.

For example, it is preferable that the resonance frequency of the acoustic resonance structure coincide with the discrete frequency sound having the largest sound pressure, more specifically, the largest A characteristic sound pressure level among the discrete frequency sounds. As a result, it is possible to effectively silence the discrete frequency sound which contributes greatly to the noise of the fan.

In addition, it is also preferable that the resonance frequency of the acoustic resonance structure coincide with the sound on the lowest frequency side among the plurality of discrete frequency sounds. In a general silencing material, it is more difficult to silence the lower frequency, and thus the low frequency sound can be selectively silenced by the resonance effect, and then the silencing material can be combined with other silencing materials.

Note that in the present invention, a case in which the resonance frequency of the acoustic resonance structure coincides with one frequency of the discrete frequency sounds of the fan means that the resonance frequency of the acoustic resonance structure is within a range of ±10% of one frequency of the discrete frequency sounds of the fan.

Note that in a case of the axial fan, in a case in which the rotation speed is defined as z (rps) and the number of blades is defined as N, the sound (discrete frequency sound) is generated strongly at a frequency of m×N×z (Hz) (m is an integer of 1 or more).

In addition, the resonance frequency of the film type resonance structure is determined by the size (size of the vibration surface, that is, a size of the opening portion of the frame 32), the thickness, the hardness, and the like of the film 34. Therefore, the resonance frequency of the film type resonance structure can be appropriately set by adjusting the size, the thickness, the hardness, and the like of the film 34.

In addition, as described above, the film type resonance structure 30a has the back space 35 on the back side of the film 34. Since the back space 35 is closed, sound absorption occurs due to the interaction between the film vibration and the back space.

Specifically, the film vibration has a frequency band of a fundamental vibration mode and a higher order vibration mode determined by the conditions of the film (thickness, hardness, size, fixing method, and the like), and a determination is made as to which mode of frequency is strongly excited to contribute to sound absorption, by the thickness of the back space and the like. In a case in which the thickness of the back space is thin, the effect is obtained in which the back space is qualitatively hardened, so that it is easy to excite the higher order vibration mode of the film vibration.

In addition, in the examples shown in FIGS. 1 and 3, the back space 35 of the film type resonance structure 30a is a closed space completely surrounded by the frame 32 and the film 34, but is not limited thereto, and the space need only be substantially divided such that the air flow is inhibited, and an opening may be provided in a part of the film 34 or the frame 32 in addition to the completely closed space. Such a form providing the opening in a part thereof is preferable from the point that a change in the sound absorption characteristic as a gas in the back space is expanded or contracted due to a temperature change, tension is applied to the film 34, and the hardness of the film 34 is changed can be prevented.

By forming a through-hole in the film 34, propagation by air propagation sound occurs. Due to the above, the acoustic impedance of the film 34 is changed. In addition, the weight of the film 34 is reduced due to the through-hole. With these, the resonance frequency of the film type resonance structure 30a can be controlled.

A position in which the through-hole is formed is not particularly limited.

The thickness of the film 34 is preferably less than 100 more preferably 70 μm or less, and still more preferably 50 μm or less. Note that in a case in which the thickness of the film 34 is not uniform, an average value thereof need only be in the above range.

On the other hand, in a case in which the thickness of the film is too thin, it is difficult to be treated. A film thickness is preferably 1 μm or more, and more preferably 5 μm or more.

A Young's modulus of the film 34 is preferably 1000 Pa to 1000 GPa, more preferably 10000 Pa to 500 GPa, and most preferably 1 MPa to 300 GPa.

A density of the film 34 is preferably 10 kg/m³ to 30000 kg/m³, more preferably 100 kg/m³ to 20000 kg/m³, and most preferably 500 kg/m³ to 10000 kg/m³.

In addition, a thickness (thickness in the direction perpendicular to the surface of the film 34) of the back space 35 is preferably 10 mm or less, more preferably 5 mm or less, and still more preferably 3 mm or less.

Note that in a case in which the thickness of the back space 35 is not uniform, an average value thereof need only be in the above range.

In addition, in the examples shown in FIGS. 1 to 3, the shape of the film type resonance structure 30a as viewed from the direction perpendicular to the surface of the film 34, that is the shape of a vibration region of the film 34 is a quadrangular shape, but the present invention is not limited thereto, and the shape thereof may be a circular shape, a polygonal shape such as a triangular shape, an elliptical shape, or the like.

In the fan silencing system according to the embodiment of the present invention, as described above, the effect is obtained due to the interaction between the sound source (sound wave) and the acoustic resonance structure due to the disposition of the acoustic resonance structure in the near field region, even in a case in which the acoustic resonance structure is not disposed such that the wind directly hits the acoustic resonance structure, the silencing effect can be obtained. From a viewpoint of ensuring the air volume of the fan, it is preferable that the acoustic resonance structure be disposed such that the air duct of the air flow generated by the fan is not blocked.

Specifically, as viewed from the direction perpendicular to the blowing port of the fan, the area in which the acoustic resonance structure and the blowing port overlap with each other is preferably 50% or less with respect to the area of the blowing port, more preferably 10% or less, and as shown in FIG. 2, still more preferably 0%, where the acoustic resonance structure and the blowing port do not overlap with each other.

In addition, in a case in which the acoustic resonance structure and the blowing port overlap with each other, it is desirable to have a structure that suppresses the generation of a wind noise while allowing the wind to flow smoothly, for example, by attaching a slope-shaped structure.

In addition, it is preferable that a surface provided with a vibrating body of the acoustic resonance structure is disposed in parallel to an axis perpendicular to the blowing port of the fan.

In an example shown in FIG. 2, the film 34 is the vibrating body of the film type resonance structure 30a, and the surface on which the film 34 of the film type resonance structure 30a is disposed is disposed in parallel to the axis perpendicular to the blowing port 16a of the axial fan 12a.

Note that in a case in which the acoustic resonance structure is the Helmholtz resonance structure or the air column resonance structure, the air in the through-hole of the resonance structure is the vibrating body, and a surface on which the through-hole is formed is the surface provided with the vibrating body.

The wind of the fan is a nonstationary fluid phenomenon, and in a case in which the nonstationary wind hits the film of the film type resonance structure and shakes the film, the vibration is generated in the film due to the wind. The vibration generated in the film includes a wide frequency spectrum, and at the frequency designed as the resonance of the film type resonance structure, a resonance vibration phenomenon occurs on a film surface. In this resonance vibration, the vibration generated in the film is likely to remain for a long time, and the resonance vibration is likely to be amplified while the fan wind continues to flow. As a result, the sound may be emitted from the resonance-vibrating film like a speaker. In particular, in a case in which the resonance structure is disposed such that the wind from the fan hits the film surface of the film type resonance structure under a condition that a strong air volume is generated from the fan, the sound is amplified around the resonance frequency of the film type resonance structure, so that the silencing effect may not be obtained.

Therefore, by adopting a configuration in which the surface provided with the vibrating body of the acoustic resonance structure is disposed in parallel to the axis perpendicular to the blowing port of the fan, the vibration of the film by the air flow generated by the fan hitting the surface provided with the vibrating body of the acoustic resonance structure can be suppressed, and the reduction in the silencing effect due to the wind can be suppressed.

Here, in the example shown in FIG. 1, the fan silencing system has a configuration in which one film type resonance structure 30a (acoustic resonance structure) is provided, but the present invention is not limited thereto, and a configuration may be adopted in which two or more acoustic resonance structures are provided.

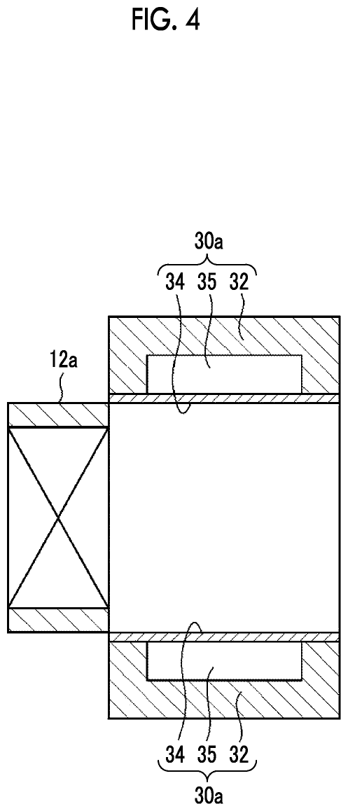

For example, as in an example shown in FIG. 4, a configuration may be adopted in which two film type resonance structures 30a are disposed at a position on the downstream side of the axial fan 12a in the blowing direction such that blowing (blowing port 16a) is not blocked.

In FIG. 4, the two film type resonance structures 30a are disposed such that the film 34 is in parallel to the rotation axis direction of the axial fan 12a, the film 34 faces the rotation axis side, and the surfaces of the two film type resonance structures 30a on the film 34 side face each other.

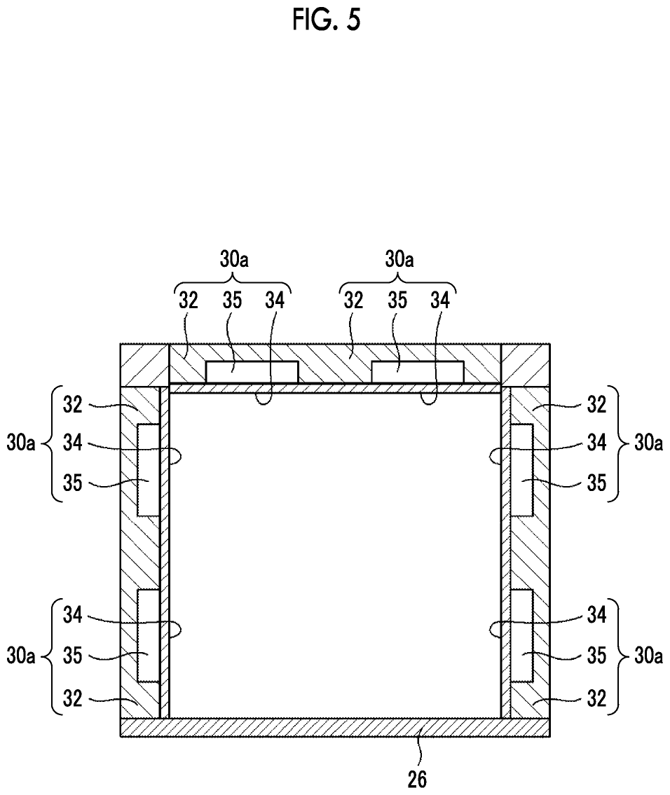

In addition, in the example shown in FIG. 4, a configuration is adopted in which the two film type resonance structures 30a are disposed to face each other, but the present invention is not limited thereto, and the film type resonance structures 30a may be disposed in the same direction with the film surfaces flush with each other as in an example shown in FIG. 5 in which the two film type resonance structures 30a are disposed on the right side of FIG. 5, the two film type resonance structures 30a are disposed on the upper side thereof, and the two film type resonance structures 30a are disposed on the left side thereof. Note that FIG. 5 is a view of the fan silencing system as viewed from the rotation axis direction of the axial fan 12a, and the axial fan 12a is not shown.

In addition, in a case in which the fan is connected to a ventilation passage, as shown in FIGS. 4 and 5, the film type resonance structure 30a (acoustic resonance structure) may constitute a part of a wall surface (pipe line 26) of the ventilation passage connected to the fan. As a result, a configuration can be adopted in which the film type resonance structure 30a is disposed at a position in which blowing (blowing port 16a) is not blocked.

In addition, in the example shown in FIG. 1 and the like, a configuration is adopted in which the film type resonance structure 30a (acoustic resonance structure) is disposed at a position directly in contact with the axial fan 12a (fan), but the film type resonance structure 30a may be disposed at a position spaced from the fan as long as the film type resonance structure 30a is disposed in the near field region of the sound generated from the fan.

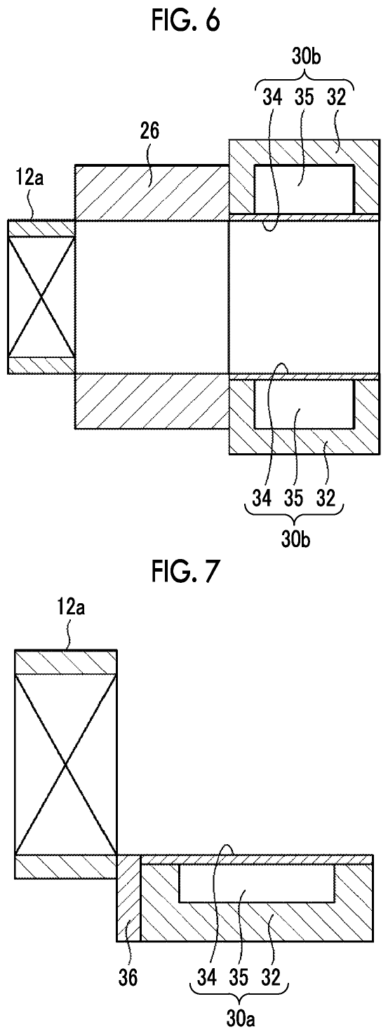

For example, in an example shown in FIG. 6, a film type resonance structure 30b is disposed at a position spaced from the axial fan 12a, and a pipe line 26 is disposed between the film type resonance structure 30b and the axial fan 12a. That is, in the example shown in FIG. 6, the pipe line 26 forming the passage of the wind generated by the axial fan 12a is connected to the downstream side of the axial fan 12a, and the film type resonance structure 30b is disposed in an end portion of the pipe line 26 on an outlet side.

From the viewpoint of disposing the acoustic resonance structure in the near field region of the sound generated by the fan, it is preferable that the acoustic resonance structure be disposed in contact with the fan or along an outer periphery of the casing of the fan. In a case in which the acoustic resonance structure is the film type resonance structure, it is preferable that the frame of the film type resonance structure be in contact with the casing of the fan. The acoustic resonance structure and the fan may be configured to be directly fixed with a screw or the like, may be configured to be fixed via a washer, or may be configured to be fixed via an adhesive or a pressure sensitive adhesive.

Alternatively, it is preferable that the acoustic resonance structure be disposed in contact with the fan via an anti-vibration member.

In an example shown in FIG. 7, a side surface of the frame 32 of the film type resonance structure 30a is in contact with the axial fan 12a via an anti-vibration member 36. By adopting a configuration in which the film type resonance structure 30a is in contact with the axial fan 12a via the anti-vibration member 36, transmission of the vibration of the axial fan 12a to the film type resonance structure 30a can be suppressed, and the generation of the sound by the film vibration of the film type resonance structure 30a due to the vibration of the axial fan 12a and integrate resonance of the axial fan 12a and the film type resonance structure 30a can be prevented.

A member generally used as an anti-vibration member, which is made of rubber, a sponge, a foam body, or the like, can be used as the anti-vibration member 36. In addition, since the anti-vibration member also serves as the sound absorbing material, for example, the porous sound absorbing material, it is possible to achieve both a wideband sound absorption effect at a high frequency and the suppression of transmission of the vibration to the resonance structure. Specifically, a foam-based sound absorbing body such as CALMFLEX F2 manufactured by INOAC CORPORATION can be used.

In addition, in a case in which the fan silencing system includes a plurality of the acoustic resonance structures, it is preferable that the acoustic resonance structures having different resonance frequencies be provided. Since the fan silencing system includes the acoustic resonance structure having different resonance frequencies, a higher silencing effect can be obtained for the plurality of discrete frequency sounds.

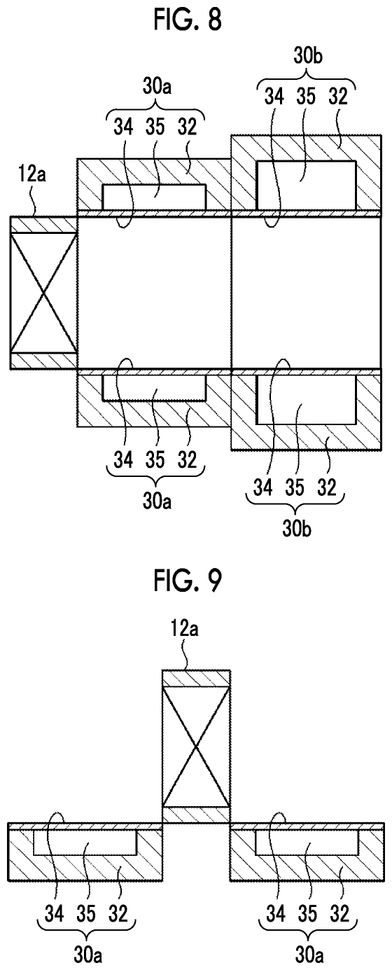

For example, in an example shown in FIG. 8, the fan silencing system includes the film type resonance structure 30a and the film type resonance structure 30b. The resonance frequency of the film type resonance structure 30a and the resonance frequency of the film type resonance structure 30b are different.

Here, in a case in which the fan silencing system includes the acoustic resonance structure having different resonance frequencies, it is preferable that the acoustic resonance structure having a high resonance frequency be disposed at a position closer to the fan than the acoustic resonance structure having a low resonance frequency.

In the example shown in FIG. 8, the resonance frequency of the film type resonance structure 30a disposed on the side close to the axial fan 12a is higher than the resonance frequency of the film type resonance structure 30b disposed on the side far from the axial fan 12a. As a result, the plurality of discrete frequency sounds can be largely silenced.

In addition, in the example shown in FIG. 1 and the like, a configuration is adopted in which the acoustic resonance structure is disposed only on the downstream side of the fan in the blowing direction of the fan, but the present invention is not limited thereto, and a configuration may be adopted in which the acoustic resonance structure is disposed on the upstream side of the fan, or as in an example shown in FIG. 9, a configuration may be adopted in which the acoustic resonance structures are disposed on the upstream side and the downstream side of the fan. For most devices, including server fans, it is desirable to that the acoustic resonance structure can be disposed in the space between the fan and a device case in order to reduce the noise that a human listens.

From the viewpoint of obtaining a higher silencing effect, it is preferable that the acoustic resonance structure be disposed at least on the downstream side of the fan, and more preferable that the acoustic resonance structure be disposed on the upstream side and the downstream side of the fan.

In a case in which a configuration is adopted in which the acoustic resonance structures are disposed on the upstream side and the downstream side of the fan, the resonance frequency of the acoustic resonance structure on the upstream side and the resonance frequency of the acoustic resonance structure on the downstream side may be the same or different.

In addition, a configuration may be adopted in which the acoustic resonance structure includes a windbreak member that transmits the sound to the surface side provided with the vibrating body.

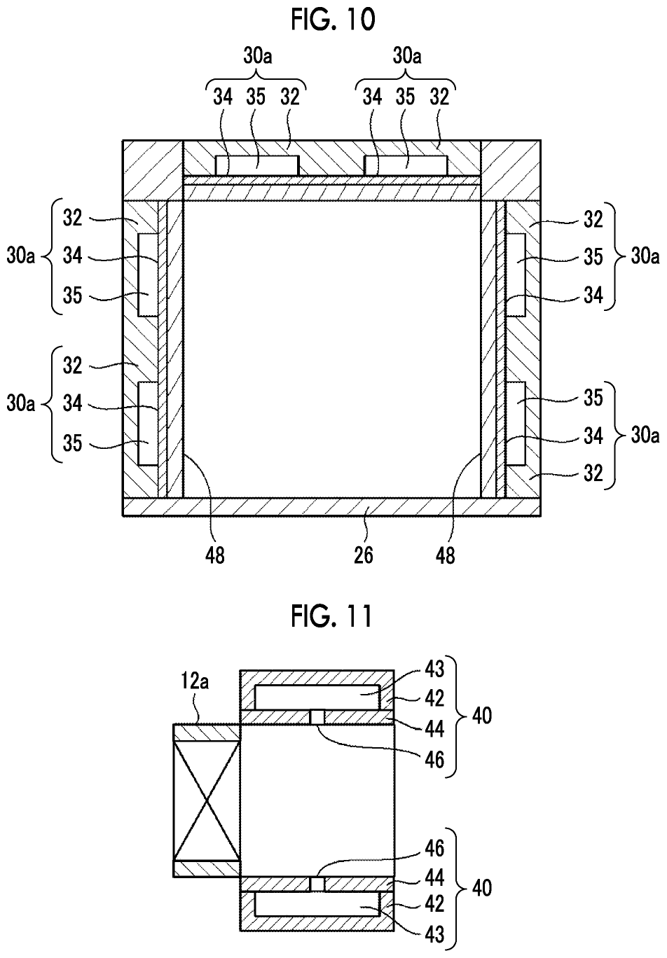

Specifically, in an example shown in FIG. 10, the fan silencing system includes the film type resonance structure 30a as the acoustic resonance structure, and a windbreak member 48 which is disposed to cover the film 34 on the surface of the film 34 which is the vibrating body of the film type resonance structure 30a.

The windbreak member 48 is a member that allows the sound to pass through and suppresses the intrusion of the wind. By disposing the windbreak member 48 on the surface of the film 34, it is possible to suppress the film vibration due to the wind pressure applied to the film, which is the vibrating body of the film type resonance structure, by the air flow generated by the fan, and it is possible to suppress reduction in the silencing effect due to the wind.

As the windbreak member 48, a porous structure such as a foam body such as a sponge, particularly a fibrous body such as an open cell foam body, a cloth, or a non-woven fabric can be used. In addition, the film can be used, such as a rubber material film such as a silicone rubber film having an extremely small young's modulus, a thin plastic film having a thickness of about 10 μm such as a wrap film, and the like, in which these film materials are loosened and fixed without being taut can be used. Since the thickness, the hardness, and the fixation thereof are extremely different from those of the film 34 of the film type resonance structure, the sound passes through without strong resonance in the audible range.

In addition, in the examples shown in FIGS. 1 to 3, a configuration is adopted in which the fan silencing system includes only the film type resonance structure 30a, but the present invention is not limited thereto, and a configuration may be adopted in which the fan silencing system further includes the porous sound absorbing material.

For example, a configuration may be adopted in which the porous sound absorbing material is provided in the space surrounded by the frame 32 and the film 34 of film type resonance structure 30a, that is, in the back space 35. Alternatively, a configuration may be adopted in which the porous sound absorbing material is provided on the surface of the film 34 of the film type resonance structure 30a.

By adopting a configuration in which the fan silencing system includes the porous sound absorbing material, it is possible to silence the sound having a frequency other than the dominant sound selectively silenced by the resonator, in a wide band. In addition, the porous sound absorbing material may be used as the windbreak member.

The porous sound absorbing material is not particularly limited, and a well-known porous sound absorbing material can be appropriately used. For example, various well-known porous sound absorbing material can be used such as foam materials and materials containing minute air such as urethane foam, soft urethane foam, wood, ceramic particle sintered material, phenol foam, and the like; fibers and fabric materials such as glass wool, rock wool, microfibers (Thinsulate manufactured by 3M), a floor mat, a carpet, a meltblown nonwoven fabric, a metal nonwoven fabric, a polyester nonwoven fabric, metal wool, felt, an insulation board and a glass nonwoven fabric, and wood wool cement board, nanofiber materials such as silica nanofiber, gypsum board, and the like.

A flow resistance of the porous sound absorbing material is not particularly limited, but is preferably 1000 to 100000 (Pa·s/m²), more preferably 3000 to 80000 (Pa·s/m²), and still more preferably 5000 to 50000 (Pa·s/m²).

The flow resistance of the porous sound absorbing material can be evaluated by measuring a perpendicular incident sound absorbance of the porous sound absorbing material having a thickness of 1 cm and fitting by the Miki model (J. Acoust. Soc. Jpn., 11(1), pp. 19 to 24 (1990)). Alternatively, an evaluation may be made according to “ISO 9053”.

In addition, a plurality of the porous sound absorbing materials having different flow resistances may be laminated.

Here, in the examples shown in FIGS. 1 to 3, a configuration is adopted in which the fan silencing system includes the film type resonance structure 30a as the acoustic resonance structure, but the present invention is not limited thereto. The fan silencing system may include the Helmholtz resonance structure and/or the air column resonance structure as the acoustic resonance structure.

FIG. 11 is a schematic cross-sectional view of an example of the fan silencing system having a configuration in which a Helmholtz resonance structure 40 is provided. The fan silencing system shown in FIG. 11 has the same configuration as the fan silencing system shown in FIG. 4 except that the Helmholtz resonance structure 40 is provided instead of the film type resonance structure 30a as the acoustic resonance structure.

In an example shown in FIG. 11, the acoustic resonance structure is the Helmholtz resonance structure 40. The Helmholtz resonance structure 40 includes a frame 42 having a prism shape and an opening portion having a bottom surface formed on one surface, a plate-shaped lid portion 44 having a through-hole 46, which covers the opening surface of the frame 42 on which the opening portion is formed to fix a peripheral portion to the frame 42. The Helmholtz resonance structure 40 has a structure in which the air in an inner space 43 surrounded by the frame 42 and the lid portion 44 serves as a spring, the air in the through-hole 46 formed in the lid portion 44 serves as a weight (mass), the mass and spring are resonated, and the sound is absorbed by thermal viscous friction in the vicinity of the wall of the through-hole 46.

In the example shown in FIG. 11, the lid portion 44 having the through-hole 46 is disposed in parallel to the rotation axis direction of the axial fan 12a, and the lid portion 44 is disposed to face the rotation axis side.

In the related art, in a case in which the Helmholtz resonance structure is used for silencing, the sound of the frequency is silenced by allowing the resonance frequency of the Helmholtz resonance structure to coincide with the frequency of the sound to be silenced. Therefore, there is a problem that the silencing effect is low for the sound of the frequency band other than the resonance frequency, and it is difficult to silence the plurality of discrete frequency sounds generated by the fan.

On the other hand, in the fan silencing system according to the embodiment of the present invention, by disposing the Helmholtz resonance structure 40 in the near field region of the sound generated by the fan, the two mechanisms of the interaction described above occur, so that the plurality of discrete frequency sounds generated by the fan can be silenced.

Even in a case in which the Helmholtz resonance structure 40 is used as the acoustic resonance structure, it is preferable that the resonance frequency of the Helmholtz resonance coincide with any one frequency of the discrete frequency sounds generated by the axial fan 12a.

The resonance frequency of Helmholtz resonance is determined by a volume of the inner space surrounded by the frame 42 and the lid portion 44, an area and a length of the through-hole 46, and the like. Therefore, the resonance frequency can be appropriately set by adjusting the volume of the inner space surrounded by the frame 42 and the lid portion 44 of the Helmholtz resonance structure 40, the area of the through-hole 46, the length, and the like.

Here, in the example shown in FIG. 11, a configuration is adopted in which the through-hole 46 is formed in the lid portion 44, but the present invention is not limited thereto, and the through-hole 46 may be formed in the frame 42. However, at this time, the outlet/inlet of the through-hole needs to face the direction in which the discrete frequency sound generated by the axial fan 12a is propagated, and in FIG. 11, the direction of the flow passage of the fan.

In addition, in the examples shown in FIG. 11, a configuration is adopted in which the Helmholtz resonance structure 40 is provided separately from the frame 42 and the lid portion 44, but the frame 42 and the lid portion 44 may be integrally formed.

In the Helmholtz resonance structure 40, the air in the through-hole 46 is the vibrating body, and the surface of the lid portion 44 having the through-hole 46 is the surface provided with the vibrating body. Therefore, it is preferable that the surface of the lid portion 44 having the through-hole 46 be disposed in parallel to the axis perpendicular to the blowing port. In addition, the windbreak member may be disposed on the surface of the lid portion 44.

In addition, the shape of the Helmholtz resonance structure 40 as viewed from the direction perpendicular to the surface of the lid portion 44 may be a quadrangular shape, a polygonal shape such as a triangular shape, a circular shape, an elliptical shape, or the like.

In the example shown in FIG. 11, a configuration is adopted in which the fan silencing system includes two Helmholtz resonance structures 40, but the present invention is not limited thereto, and a configuration may be adopted in which one Helmholtz resonance structure is provided, or a configuration may be adopted in which three or more Helmholtz resonance structures are provided. In the case of a configuration in which a plurality of the Helmholtz resonance structure are provided, the frames of the Helmholtz resonance structure may be integrally formed, or the inner space may be shared.

In addition, in a case of a configuration in which a plurality of Helmholtz resonance structures are provided, a configuration may be adopted in which the Helmholtz resonance structures having different resonance frequencies are provided.

In addition, in the present invention, the resonator provided in the silencer may be the air column resonance structure.

In the air column resonance structure, the resonance occurs by generating a standing wave in a resonance pipe having an opening.

In the related art, in a case in which the air column resonance structure is used for silencing, the sound of the frequency is silenced by allowing the resonance frequency of the air column resonance structure to coincide with the frequency of the sound to be silenced. Therefore, there is a problem that the silencing effect is low for the sound of the frequency band other than the resonance frequency, and it is difficult to silence the plurality of discrete frequency sounds generated by the fan.

On the other hand, in the fan silencing system according to the embodiment of the present invention, by disposing the air column resonance structure in the near field region of the sound generated by the fan, the two mechanisms of the interaction described above occur, so that the plurality of discrete frequency sounds generated by the fan can be silenced.

Even in a case in which the air column resonance structure is used as the acoustic resonance structure, it is preferable that the resonance frequency of the air column resonance coincide with any one frequency of the discrete frequency sounds generated by the fan.

The resonance frequency of the air column resonance is determined by a length of the resonance pipe and the like. Therefore, the frequency of the resonating sound can be appropriately set by adjusting the depth of the resonance pipe, the size of the opening, and the like.

Note that in a case in which a configuration is adopted in which the acoustic resonance structure has the inner space and the through-hole (opening portion) which communicates the inner space with the outside, whether a resonance structure causing air column resonance or a resonance structure causing Helmholtz resonance is provided is determined in response to the size and position of the through-hole, the size of the inner space, and the like. Therefore, by adjusting the above appropriately, it is possible to select whether the air column resonance or the Helmholtz resonance is adopted as the resonance structure.

In the case of air column resonance structure, in a case in which the opening portion is narrow, the sound wave is reflected at the opening portion and it is difficult for the sound wave to enter the inner space, and thus it is preferable that the opening portion be wide to a certain extent. Specifically, in a case in which the opening portion has a rectangular shape, the length of the short side is preferably 1 mm or more, more preferably 3 mm or more, and still more preferably 5 mm or more. In a case in which the opening portion has a circular shape, it is preferable that the diameter be in the range described above.

On the other hand, in the case of Helmholtz resonance structure, it is necessary to generate thermal viscous friction at the through-hole, and thus it is preferable that the through-hole be narrow to a certain extent. Specifically, in a case in which the through-hole has a rectangular shape, the length of the short side is preferably 0.5 mm or more and 20 mm or less, more preferably 1 mm or more and 15 mm or less, and still more preferably 2 mm or more and 10 mm or less. In a case in which the through-hole has a circular shape, it is preferable that the diameter be in the range described above.

Note that the fan silencing system according to the embodiment of the present invention may have a configuration in which different types of acoustic resonance structures are provided. For example, a configuration may be adopted in which the Helmholtz resonance structure and the film type resonance structure are provided.

Here, it is preferable to use the film type resonance structure as the acoustic resonance structure from viewpoints of size reduction and thinning.

Examples of materials of the film type resonance structure and the frames and the lid portions of the Helmholtz resonance structure and the air column resonance structure (hereinafter, collectively referred to as a “frame material”) include a metal material, a resin material, a reinforced plastic material, a carbon fiber, and the like. Examples of the metal material include metal materials such as aluminum, titanium, magnesium, tungsten, iron, steel, chromium, chromium molybdenum, nichrome molybdenum, copper, alloys thereof, and the like. In addition, examples of the resin material include resin materials such as an acrylic resin, polymethyl methacrylate, polycarbonate, polyamide-imide, polyarylate, polyetherimide, polyacetal, polyether ether ketone, polyphenylene sulfide, polysulfone, polyethylene terephthalate, polybutylene terephthalate, polyimide, an acrylonitrile, butadiene, styrene copolymer synthetic resin (ABS resin), polypropylene, triacetyl cellulose, and the like. In addition, examples of the reinforced plastic material include carbon fiber reinforced plastics (CFRP), and glass fiber reinforced plastics (GFRP). In addition, natural rubber, chloroprene rubber, butyl rubber, ethylene/propylene/diene rubber (EPDM), silicone rubber, and the like, and rubber containing these crosslinked structures are exemplary examples.

In addition, as the frame material, various honeycomb core materials can be used. Since the honeycomb core material is lightweight and used as a highly rigid material, ready-made product thereof is easily available. As the frame, it is possible to use the honeycomb core material made of various materials such as aluminum honeycomb core, FRP honeycomb core, paper honeycomb core (manufactured by Shin Nippon Feather Core Co., Ltd, manufactured by Showa Aircraft Group Co., Ltd., or the like), thermoplastic resin (PP, PET, PE, PC, or the like) honeycomb core (TECCELL manufactured by Gifu Plastic Industry Co., Ltd., or the like).

In addition, a structure including air, that is, a foam material, a hollow material, a porous material, or the like can also be used as the frame material. In order to prevent the ventilation between cells in a case in which a large number of resonators are used, for example, a closed cell foam material and the like can be used to form the frame. For example, various materials such as closed cell polyurethane, closed cell polystyrene, closed cell polypropylene, closed cell polyethylene, and a closed cell rubber sponge can be selected. By using closed cell material, sound, water, gas, or the like is not allowed to pass through, and the structural strength is high as compared with an open cell material, and thus it is suitable for being used as the frame material. In addition, in a case in which the porous sound absorbing body described above has sufficient supportability, the frame may be formed only by the porous sound absorbing body, and examples of the porous sound absorbing body and the material of the frame are used in combination by for example, mixing or kneading. As described above, the weight of the device can be reduced by using the material system including air inside. In addition, the heat insulating property can be imparted.

Here, from the viewpoint of disposition at a high temperature position, it is preferable that the frame material be made of a material having higher heat resistance than the flame retardant material. The heat resistance can be defined, for example, by the time that satisfies each item of Article 108-2 of the Building Standards Law Enforcement Ordinance. In a case in which the time that satisfies each item of Article 108-2 of the Building Standards Law Enforcement Ordinance is 5 minutes or more and less than 10 minutes, it is a flame retardant material, in a case in which the time is 10 minutes or more and less than 20 minutes, it is a semi-incombustible material, and in a case in which the time is 20 minute or more, it is a non-combustible material. However, in many cases, the heat resistance is defined for each field. Therefore, the frame material need only be made of a material having the heat resistance equivalent to or higher than the flame retardance defined in the field in response to the field in which the fan silencing system is used.

The wall thicknesses of the frame and the lid portion (frame thickness) are not particularly limited, and can be set in response to, for example, the size of the opening cross section of the frame.

Examples of the film 34 include various metals such as aluminum, titanium, nickel, permalloy, 42 alloy, kovar, nichrome, copper, beryllium, phosphor bronze, brass, nickel silver, tin, zinc, iron, tantalum, niobium, molybdenum, zirconium, gold, silver, platinum, palladium, steel, tungsten, lead, and iridium; and the resin materials such as polyethylene terephthalate (PET), triacetyl cellulose (TAC), polyvinylidene chloride (PVDC), polyethylene (PE), polyvinyl chloride (PVC), polymethylpentene (PMP), cycloolefin polymer (COP), zeonoa, polycarbonate, polyethylene naphthalate (PEN), polypropylene (PP), polystyrene (PS), polyarylate (PAR), aramid, polyphenylene sulfide (PPS), polyether sulfone (PES), nylon, polyester (PEs), cyclic olefin copolymer (COC), diacetyl cellulose, nitro cellulose, cellulose derivative, polyamide, polyamide-imide, polyoxymethylene (POM), polyetherimide (PEI), polyrotaxane (slide ring material or the like), and polyimide. Further, a glass material such as thin film glass and a fiber reinforced plastic material such as carbon fiber reinforced plastic (CFRP) and glass fiber reinforced plastic (GFRP) can also be used. In addition, natural rubber, chloroprene rubber, butyl rubber, EPDM, and silicone rubber, and rubber having these crosslinked structures can be used. Alternatively, the combination thereof may be used.

In addition, in a case in which the metal material is used, the surface may be metal-plated from the viewpoint of suppressing rust.

From the viewpoint of excellent durability against heat, ultraviolet rays, external vibration, or the like, it is preferable to use the metal material as the material of the film 34 in applications requiring durability.

In addition, a fixing method of the film or the lid portion to the frame is not particularly limited, and a method of using a double-sided tape or an adhesive, a mechanical fixing method such as screwing, crimping or the like can be appropriately used. The fixing method can also be selected from the viewpoints of heat resistance, durability, and water resistance as in the case of the frame material and the film. For example, as the adhesive, “Super X” series manufactured by CEMEDINE Co., Ltd., “3700 series (heat resistant)” manufactured by ThreeBond Holdings Co., Ltd., heat resistant epoxy adhesive “Duralco series” manufactured by TAIYO WIRE CLOTH CO., LTD., and the like can be selected. In addition, as the double-sided tape, Ultra High Temperature Double Coated Tape 9077 manufactured by 3M or the like can be selected. As described above, various fixing methods can be selected for the required characteristic.

Here, in the example shown in FIG. 1 and the like, a configuration is adopted in which the fan silencing system includes the axial fan 12a as the fan and the noise of the axial fan (propeller fan) is suppressed, but the present invention is not limited thereto, and a known fan in the related art, such as a sirocco fan, a turbo fan, a centrifugal fan, or a line flow fan, can be applied to the fan.

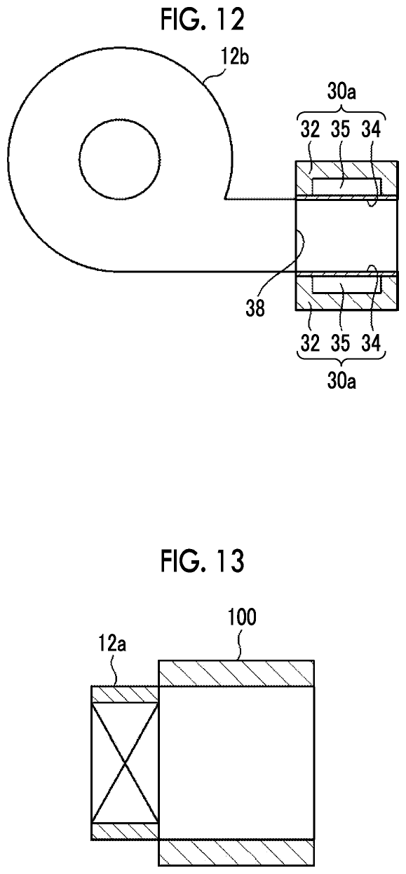

The sirocco fan takes in air from the rotation axis direction of the rotor including blade, supplies the air in the direction perpendicular to the rotation axis, and has the blowing port on the side surface. Therefore, for example, as shown in FIG. 12, in a case in which the fan is a sirocco fan 12b, the film type resonance structure 30a (acoustic resonance structure) is disposed to be in contact with a blowing port 38. A configuration of the film type resonance structure 30a is the same as the example shown in FIG. 1 and the like.

In an example shown in FIG. 12, the film type resonance structure 30a is disposed at a position in which the blowing port of the sirocco fan 12b is not blocked. In addition, in the film type resonance structure 30a, the film 34 is disposed in parallel to the direction perpendicular to the blowing port of the sirocco fan 12b, and the film 34 faces the blowing port side.

Even in a case of the sirocco fan, the sound is generated from the blade portion of the fan, and thus a region at a distance of less than λ/4 from the blade portion of the fan is the near field region. Therefore, by disposing the acoustic resonance structure in the near field region, the two interactions occur in the near field region, so that the silencing effect can be obtained.

### EXAMPLES

The present invention will be described below in more detail with reference to examples. The materials, the usage amounts, the ratios, the processing contents, the processing procedures, and the like shown in the following examples can be appropriately changed without departing from the spirit of the present invention. Therefore, the scope of the present invention should not be construed as being limited by the following examples.

### Comparative Example 1

An axial fan (Model: 109P0612K701 manufactured by SANYO DENKI CO., LTD.) was used as the fan. The axial fan has an outer diameter of 60 mm×60 mm and a thickness of 15 mm. Since the casing was attached to the exhaust direction side of the fan, a distance from a front end portion of the blowing port to the rotor blade was about 5 mm.

In order to suppress an influence of solid vibration from the fan, anti-vibration rubber with a thickness of 5 mm was disposed under the fan. In addition, in order to suppress the sound emitted as the solid vibration from the side of the fan, the side surface of the casing of the fan was surrounded by acrylic having a thickness of 5 mm.

By cutting out and combining a rectangular plate with a short side of length of 30 mm using an acrylic plate having a thickness of 5 mm, a square duct having an inner diameter of 60 mm square equal to the outer diameter of the fan and a length in a duct direction of 30 mm was produced. An acrylic plate was processed by using a laser cutter.

This duct was disposed on the surface of the fan on the blowing port side such that the cross section of the air duct of the fan coincides with the duct. By connecting the frame surrounding the casing of the fan and the outside of the duct with a tape and closing the frame and the outside of the duct completely, a structure in which the duct is intimate attached to the fan was produced as shown in FIG. 13.

<Measurement>

The sound volume was measured by driving the fan by using the produced structure.

In the measurement of the sound, a microphone (½ inch microphone 4152 manufactured by ACO, Co, Ltd.) was disposed at a position 200 mm spaced from a center position of the fan in the axial direction at a point offset by 50 mm from a central axis in a horizontal direction and a perpendicular direction in order to avoid an influence of the wind. The microphones were disposed on both an exhaust side and an intake side.

The fan was driven by using a regulated DC power supply. A driving condition of the fan was 12 V and 0.25 A.

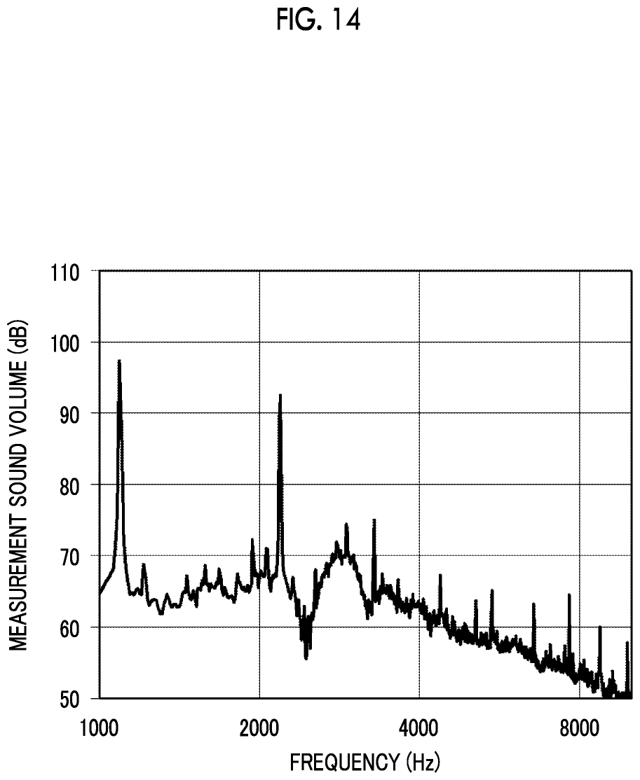

The measurement results with the microphone on the exhaust side are shown in FIG. 14. A horizontal axis of a graph shown in FIG. 14 is a logarithmic display. From FIG. 14, it was found that a large peak sound (narrow band sound), which is a characteristic of a fan with a rotating blade, appeared at a plurality of frequencies. That is, it was found that discrete frequency sounds were generated. Among them, a large peak had in an integral multiple relationship. In particular, the sound volumes of 1.1 kHz and 2.2 kHz were high.

A wind speed at the outlet side end portion of the duct was a wind speed of 3.1 m/s, which was measured by using an anemometer. Hereinafter, a change in the wind speed was not observed until Example 3.

### Example 1

The fan silencing system was produced in the same manner as in Comparative Example 1 except that an inner wall of the duct had the film type resonance structure produced as described below. The resonance frequency of the film type resonance structure was 2.2 kHz.

<Design of Film Type Resonance Structure>

The film type resonance structure was designed by performing acoustic structure coupled calculation by a finite element method by using COMSOL MULTIPHYSICS (manufactured by COMSOL INC.). A design was made by using PET as a film material, setting a thickness to 75 μm, and changing a size and a back distance. It was found that the film type resonance structure having a circular frame with an inner diameter of 24 mm, which is a vibration portion of the film, and a back distance of 6 mm had the resonance at 2.2 kHz and had high absorption.

It was found that the back distance of 6 mm corresponds to a distance of 0.038×λ with respect to a wavelength λ, of 2.2 kHz, and the resonance could be realized with a very thin structure. In a case of a normal one-sided closed pipe air column resonance structure, a required length was 0.25×λ, and thus it was found that the thickness could be reduced to a size of about 15% of the air column resonance structure.

<Production of Film Type Resonance Structure>

The structure designed described above was produced by processing an acrylic plate with the laser cutter. Specifically, by processing an acrylic plate having a thickness of 3 mm, two square perforated plate members each having an outer shape of 30 mm and having an opening portion with a diameter of 24 mm therein, and a square plate member having an outer shape of 30 mm were produced. The two perforated plate members and the plate member were superposed in this order and bonded with a double-sided tape (GENBA NO CHIKARA manufactured by ASKUL Corporation) to produce the frame.

A PET film (Lumirror manufactured by TORAY INDUSTRIES, INC.) having a thickness of 75 μm was attached to the opening surface of the frame with a double-sided tape. By cutting out the PET film in response to the outer shape of the frame, the film type resonance structure having an outer shape of 30 mm square, an inner shape of the frame of 24 mm, a PET film thickness of 75 μm, and a back distance of 6 mm was produced.

Six film type resonance structures were produced, and the duct (length 30 mm) including two film type resonance structures on three surfaces, respectively, among the four surfaces of the duct was produced (see FIG. 5).

<Measurement>

The fan of the produced fan silencing system was driven, and the sound volume was measured on the exhaust side and the intake side in the same manner as in Comparative Example 1.

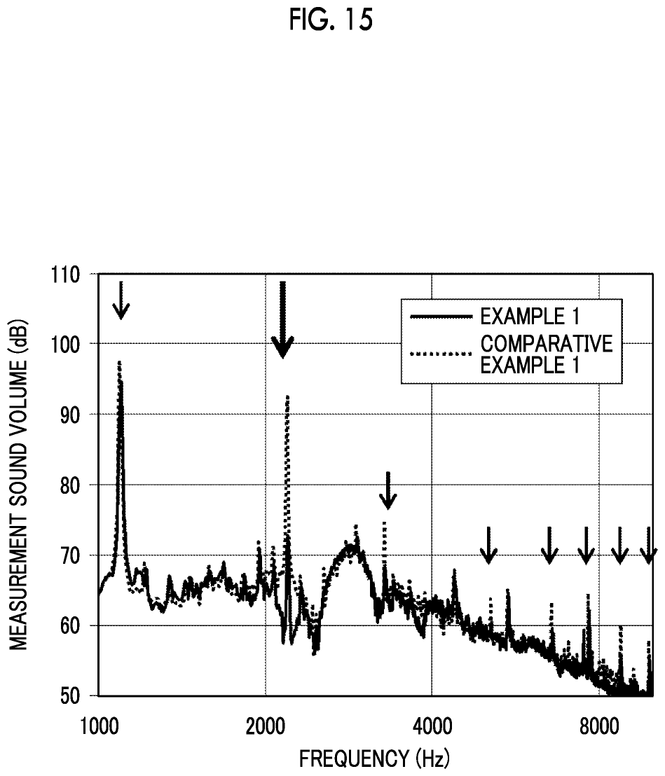

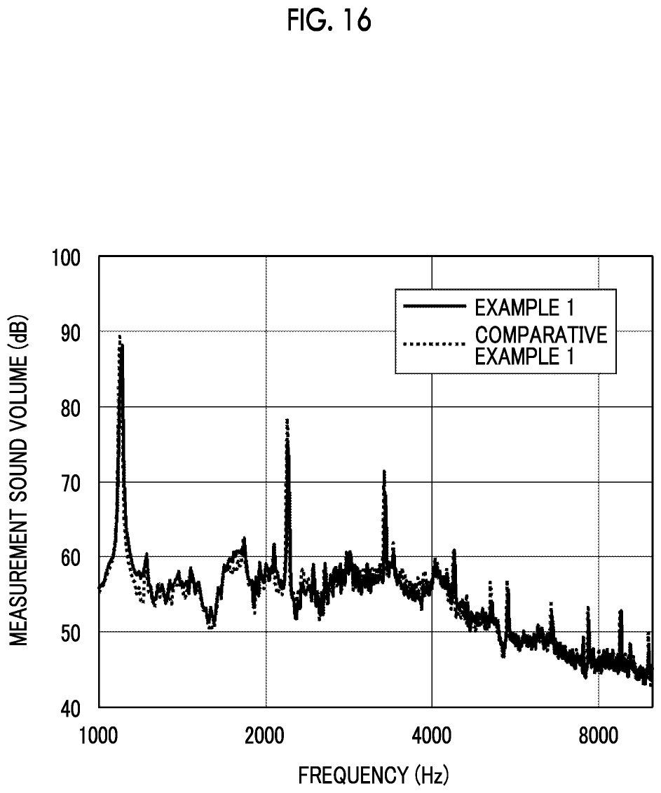

The measurement results on the exhaust side are shown in FIG. 15, and the measurement results on the intake side are shown in FIG. 16. FIGS. 15 and 16 also show the results of Comparative Example 1.

From FIG. 15, it was found that a large silencing effect of about 20 dB could be obtained at a resonance frequency of 2.2 kHz of the film type resonance structure. Further, it was found that the silencing effect could be obtained for the plurality of discrete frequency sounds having different frequencies generated by the rotation of the fan, which are indicated by arrows in FIG. 15. That is, it was found that the silencing effect could be obtained even at a frequency other than the resonance frequency of the film type resonance structure. As described above, it was found that in the fan silencing system according to the embodiment of the present invention, the sound of the frequency other than the resonance frequency of the acoustic resonance structure could be silenced by disposing the acoustic resonance structure in the near field region of the sound generated by the fan, so that the plurality of discrete frequency sounds having different frequencies generated by the rotation of the fan can be silenced.

In addition, it was found that by allowing the resonance frequency of the film type resonance structure to coincide with one frequency of the plurality of discrete frequency sounds having different frequencies generated by the rotation of the fan, the silencing effect at the frequency could be further improved.

In addition, from FIG. 16, it was found that the sound volume was also reduced at the resonance frequency of the film type resonance structure and other frequencies on the intake side as well. That is, it was found that as for the silencing effect on the exhaust side, the sound was not reflected toward the intake side, and both the exhaust side and the intake side were silenced. It was considered that this effect was due to the absorption of sound due to the film vibration by the film type resonance structure, and the suppression of the phenomenon that the sound is emitted from the sound source by the interference between the sound reflected by the film type resonance structure and the sound source.

In the fan silencing system of Example 1, the distance between the sound source portion (blade) of the fan and the center of the vibration portion of the film of the film type resonance structure satisfied “distance from the front surface of the blade of the fan to the front surface of the blowing port of 5 mm”+“distance from the center position of the film of the film type resonance structure to the front surface of the blowing port of the fan of 15 mm”=20 mm. Since wavelength/4 at a frequency of 2.2 kHz was 39 mm, it was found that the film type resonance structure was disposed in the near field region.

### Comparative Example 2

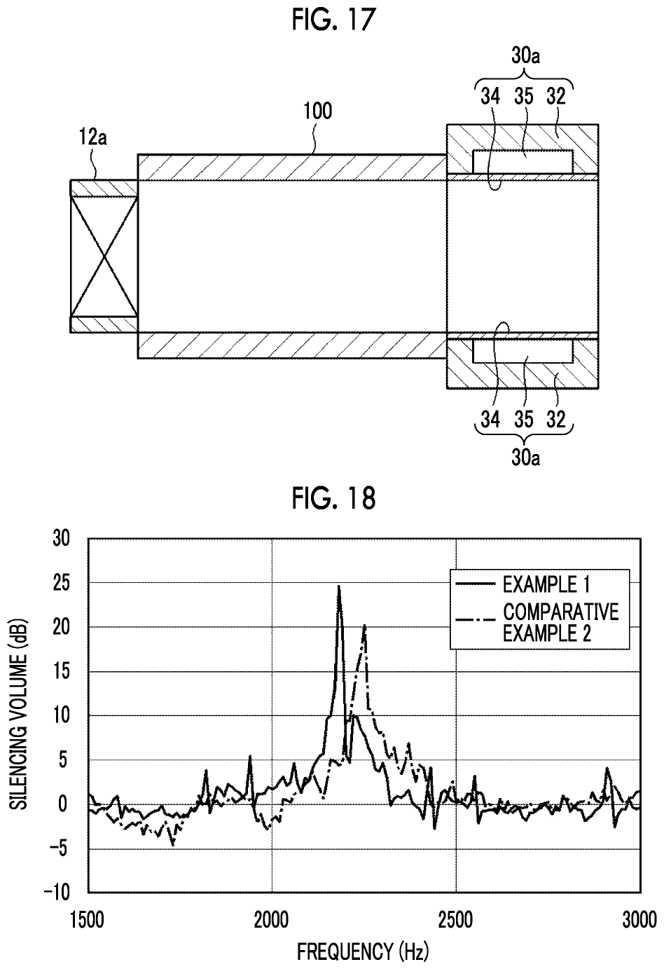

In Comparative Example 2, as shown in FIG. 17, a configuration was adopted in which the film type resonance structure 30a is disposed to be spaced from the axial fan 12a, and a duct 100 is disposed between the film type resonance structure 30a and the axial fan 12a. As the film type resonance structure 30a, the same film type resonance structure as in Example 1 was used. The duct 100 was the same as the duct of Comparative Example 1 except that a length was 60 mm.

In this configuration, a distance between the sound source portion (blade) of the fan and the film type resonance structure was 80 mm. Therefore, a configuration was adopted in which the film type resonance structure 30a was disposed outside the near field region.

<Measurement>

The fan of the fan silencing system of Comparative Example 2 was driven, and the sound volume was measured on the exhaust side and the intake side in the same manner as in Comparative Example 1. Note that in Comparative Example 2, the silencing volume was obtained from a difference by comparing the measurement results of the sound volume in a case in which a portion of each film type resonance structure 30a was replaced with the duct.

The results are shown in FIG. 18.

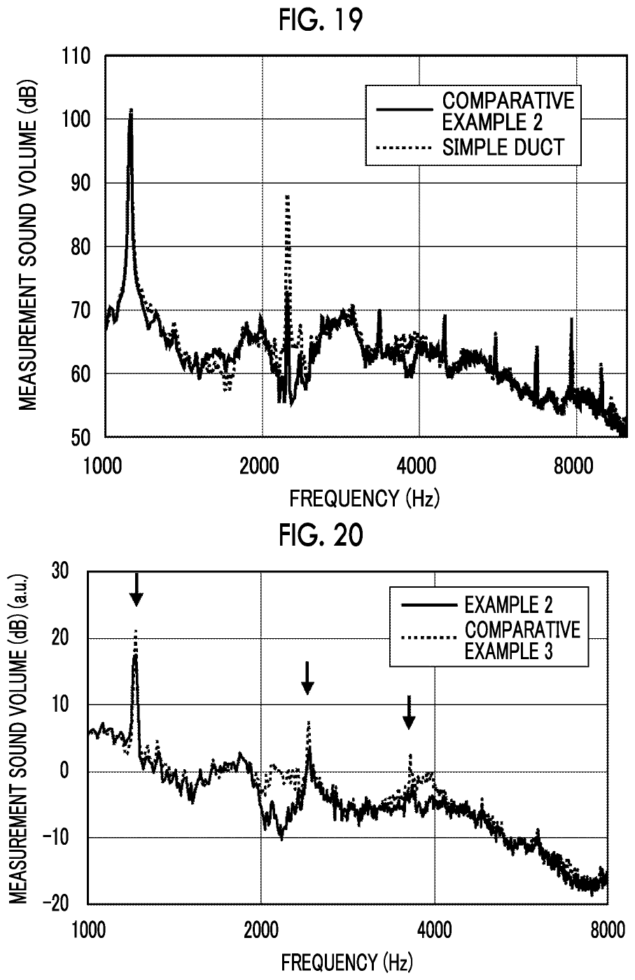

In addition, FIG. 19 shows the measurement results of the sound volume of Comparative Example 3 and in a case in which the portion of the film type resonance structure 30a of Comparative Example 3 was replaced with the duct (simple duct).

From FIG. 18, it was found that in Comparative Example 2, the sound could be silenced at the resonance frequency of the film type resonance structure 30a.

However, from FIG. 19 in which the frequency range is further expanded, it was found that in the structure of Comparative Example 3, the silencing effect could not be obtained at a frequency other than the resonance frequency of the film type resonance structure 30a.

In Comparative Example 2, since the film type resonance structure and the sound source were spaced by λ/2, the silencing effect appeared due to the interference effect (distant field interference) as a normal sound wave. On the other hand, since it was considered that the mechanism described above in the near field region did not occur, it was natural that the mechanism did not contribute to silencing at a frequency other than the resonance frequency of the film type resonance structure.

On the other hand, in a case in which the film type resonance structure was disposed in the near field region as in Example 1, it was necessary to treat the interaction between the film type resonance structure and the sound source in an integrated manner, and to further consider the interaction with the near field sound of a high wave number that is not propagated to a long distance. In this case, it was considered that the mechanism described above also contributed to a release amount of the sound at a frequency other than the resonance frequency of the film type resonance structure. Therefore, in the near field region, it is possible to obtain the silencing effect with respect to the sound in a wide frequency band.

From the above results, it was found that by disposing the film type resonance structure in the near field region as in Example 1 of the present invention, the plurality of discrete frequency sounds generated by the fan could be silenced. In addition, it was found that by allowing the resonance frequency of the film type resonance structure to coincide with one frequency of the discrete frequency sounds, a higher silencing effect could be obtained at this frequency. In addition, it was found that the noise of the fan could be silenced without blocking the air duct.

### Example 2

By using the same film type resonance structure as in Example 2, a study was performed by changing the peak sound frequency by changing a type of fan. A DC axial fan “9GA0612G9001” (frame size of 60 mm and thickness of 10 mm) manufactured by SANYO DENKI CO., LTD. was used. The measurement was performed for a case in which the fan is fixed in the same as in Example 1 and the same film type resonance structure as in Example 1 was attached to the exhaust side (Example 2) and a case in which the resonance structure was not disposed at the same position and the duct having a length of 30 mm, which was the same duct length, was attached (Comparative Example 3).

The measurement results are shown in FIG. 20. In a case of this fan, the frequency of the peak sound appeared at a frequency deviating from the resonance frequency of the film type resonance structure. The silencing effect of about 8 dB appeared relatively widely around 2.2 kHz, which is the resonance frequency of the film type resonance structure. On the other hand, it was found that at the peak sound frequency (1.2 kHz, 2.4 kHz, and 3.6 kHz) of the fan, the sound could be silenced from the original peak sound volume in a case in which the film type resonance structure was in the near field region.

As described above, it was found that the peak sound could be silenced by the resonance structure in the near field region even at the peak sound frequency of the fan deviating from the resonance frequency of the film type resonance structure.

Note that regarding the silencing volume of the peak sound, it was found that a case of Example 1 in which the resonance frequency coincides with the peak sound frequency of the fan had a large silencing volume, which was more preferable, than a case in which the resonance frequency deviates from the peak sound frequency of the fan as in Example 2.

### Example 3

The film type resonance structure was produced in the same manner as in Example 1 except that the resonance frequency of the film type resonance structure was 1.1 kHz.

<Production of Film Type Resonance Structure>

The design was made by the finite element method by using COMSOL MULTIPHYSICS, so that it was found that the resonance frequency became 1.1 kHz by setting the back distance of the film type resonance structure of Example 1 from 6 mm to 15 mm. An acrylic plate was processed with the laser cutter to produce this film type resonance structure by the same method as in Example 1.

The produced film type resonance structure was disposed at a position 30 mm spaced from the surface of the blowing port of the fan. The duct (pipe line) was connected between the film type resonance structure and the fan (see FIG. 6). The distance from the center of the film type resonance structure to the sound source portion (blade) of the fan was 50 mm. On the other hand, since wavelength/4 at a frequency of 1.1 kHz was 78 mm, it was found that the film type resonance structure was disposed in the near field region.

<Measurement>

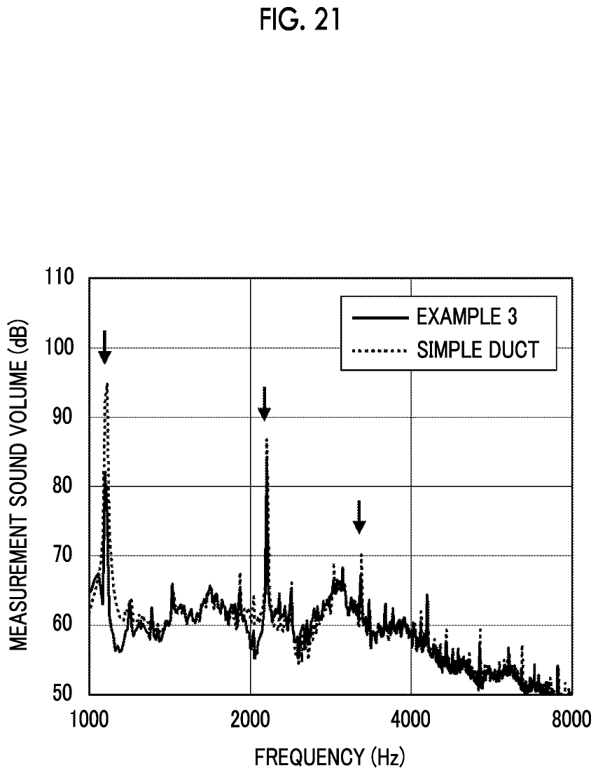

The fan of the produced fan silencing system was driven, and the sound volume was measured on the exhaust side and the intake side in the same manner as in Example 1. The results are shown in FIG. 21. In addition, FIG. 21 also shows the measurement results of the sound volume in a case in which the film type resonance structure of Example 3 was replaced with the duct (simple duct).

From FIG. 21, it was found that a large silencing effect of about 10 dB could be obtained at a resonance frequency of 1.1 kHz of the film type resonance structure. Further, it was found that the silencing effect could be obtained for the plurality of discrete frequency sounds generated by the fan.

### Example 4

The fan silencing system was produced in the same manner as in Example 1 except that a configuration (see FIG. 8) was adopted in which the film type resonance structure produced in Example 3 was disposed on the downstream side of the film type resonance structure of the fan silencing system of Example 1.

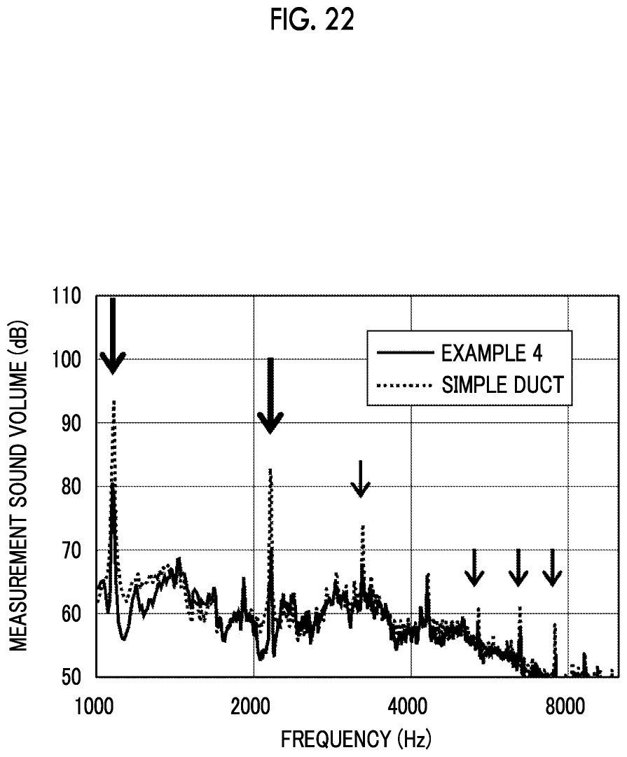

The results are shown in FIG. 22. In addition, FIG. 22 also shows the measurement results of the sound volume in a case in which the film type resonance structure of Example 4 was replaced with the duct (simple duct).

It was found that a large silencing effect of about 15 dB could be obtained at a resonance frequency of 1.1 kHz and a resonance frequency of 2.2 kHz of the film type resonance structure, respectively. That is, it was found that even in a case in which the film type resonance structures were disposed in series, the respective silencing effects functioned.

In addition, it was found that the silencing effect could be obtained for the plurality of discrete frequency sounds generated by the fan, which are indicated by arrows in FIG. 22. That is, it was found that the silencing effect could be obtained even at a frequency other than the resonance frequency of the film type resonance structure.

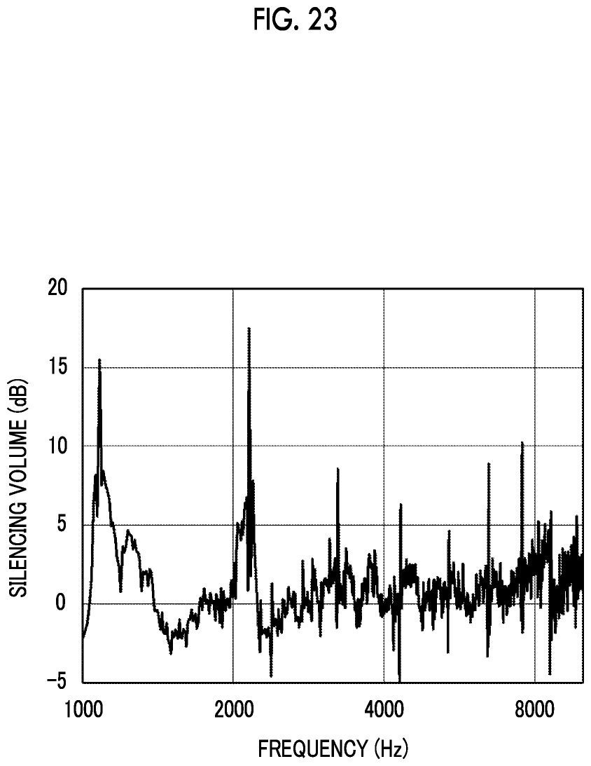

A difference between the two data in FIG. 22 is obtained and shown in FIG. 23 as the silencing volume. It was found that the noise peak of the fan was silenced by 15 dB or more around 1.1 kHz and around 2.2 kHz, and the silencing effect was obtained in other frequency bands as well.

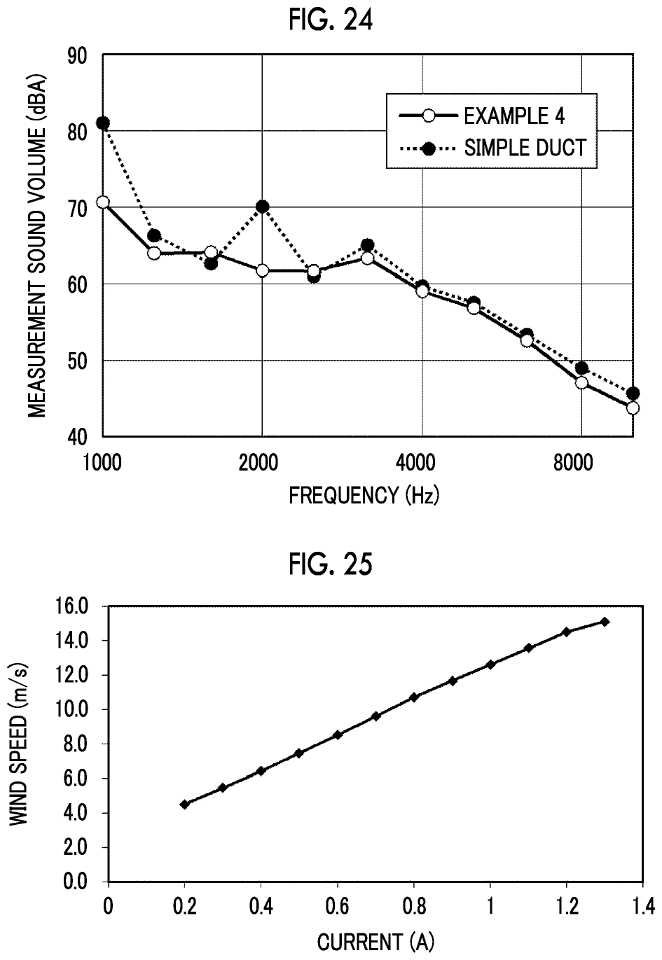

In order to evaluate the volume of the noise heard by the ear regarding the fan silencing system of Example 4, an octave band evaluation and an overall noise volume evaluation are shown. FIG. 24 shows the results of evaluation for each ⅓ octave band and A characteristic evaluation (unit: dBA) in which the sound volume was corrected in consideration of the sensitivity of the human ear. It was found that by silencing the noise peaks of 1.1 kHz, 2.2 kHz, and other frequencies, the sound was reduced as a whole even in the ⅓ octave band evaluation in which the frequencies were widely averaged and evaluated. In addition, a noise level was calculated by performing A characteristic correction and integration on the entire frequency audible range. The noise level, which was noise of 81.9 (dBA) in a case of the simple duct, could be reduced to 74.9 (dBA) in the fan silencing system of Example 4. In a case in which the noise level has a difference of 3 dBA, a normal person can sufficiently detect the noise, so that the silencing effect at 7 dBA is a level that can be felt to be sufficiently quiet.

As described above, it was shown that as a result of performing a study to suppress the discrete frequency sounds generated by the fan, the discrete frequency sounds generated by the fan as a whole in addition to the resonance frequency were silenced by disposing the acoustic resonance structure in the near field region, and a large silencing effect could be obtained.

### Example 5

The type of the fan was changed in order to carry out the measurement under a stronger wind condition than in Examples 1 to 4. A fan 9GA0612P1J03 (thickness of 38 mm) manufactured by SANYO DENKI CO., LTD. was used. FIG. 25 shows the wind speed in a case in which an amount of current supplied to the fan was changed. By increasing the amount of current, a high wind speed and a high air volume could be obtained.

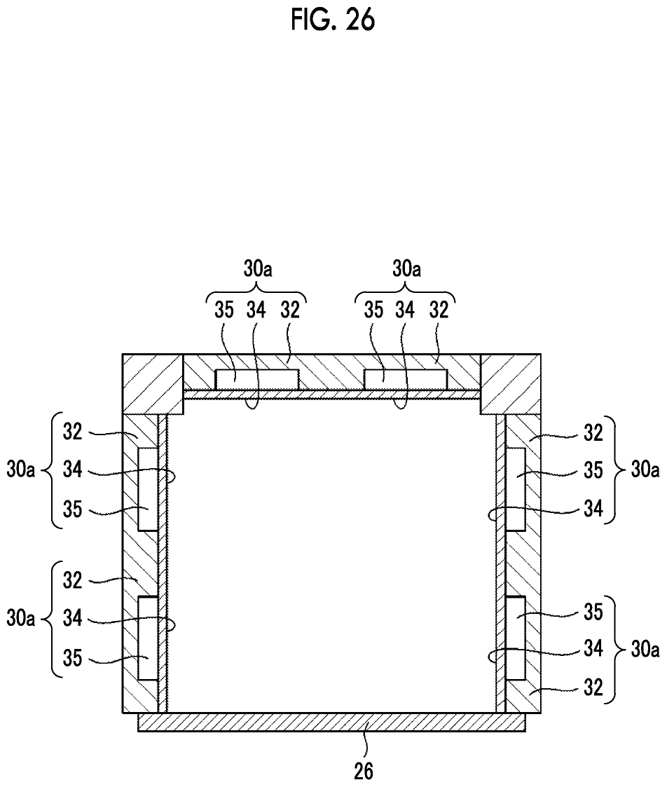

The film type resonance structure having the same configuration as that of Example 2 was disposed on the exhaust side of the fan. However, the film surface of the film type resonance structure was formed to be lowered by 5 mm to the outer peripheral side (see FIG. 26) than in Example 2. The reason of the above is to dispose the windbreak member in Example 6 described below.

<Measurement>

The fan of the produced fan silencing system was driven, and the sound volume was measured on the exhaust side and the intake side in the same manner as in Comparative Example 1.

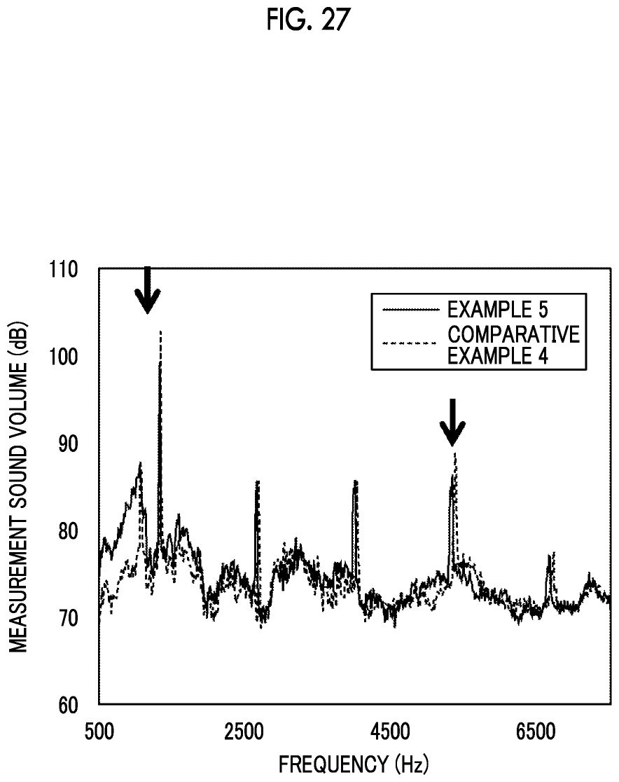

The measurement results on the exhaust side are shown in FIG. 27. In addition, FIG. 27 also shows the measurement results in a case in which the film type resonance structure of Example 5 is replaced with the duct, as Comparative Example 4. In Example 5 and Comparative Example 4, the structure lengths in the flow passage direction were both 30 mm, which were equal.

In addition, the wind speeds at the outlet side end portions of Example 4 and Comparative Example 4 were measured by using the anemometer. As a result, it was confirmed that both wind speeds were 14.5 m/s, and the wind speed was not changed between a case in which the film type resonance structure was attached and a case of a tubular structure.

From FIG. 27, it was found that the silencing effect could be obtained at a peak at a frequency other than the resonance frequency of the film type resonance structure, as shown by arrows in FIG. 27. However, it was found that at the peak around 1.1 kHz, which is the resonance frequency, there was an effect that the sound was amplified at the frequencies around 1.1 kHz, and a peak silencing effect was hardly obtained.

In Example 5, the air volume of the fan was large and the fan was rotated, and thus the air was nonstationary. Since the wind applied the wind pressure to the film surface, the vibration due to the wind was generated on the film surface. The vibration generated in the film included a wide frequency spectrum, but among them, the resonance phenomenon occurred at a frequency designed as the resonance by the design of the film type resonance structure, that is, a frequency aimed at silencing and around thereof. At this resonance frequency, the vibration generated on the film surface was likely to remain for a long time, and the amplitude thereof was also likely to be amplified in a state in which the fan continues to operate. Therefore, the sound was emitted like a speaker. As described above, it was considered that in a case in which a strong air volume is generated in the immediate vicinity of the fan, the sound was amplified around the resonance frequency, and thus a target silencing effect was hardly obtained.

### Example 6

In the fan silencing system of Example 5, the fan silencing system was produced in the same manner as in Example 5 except that the windbreak member was disposed on the surface of the film including the film type resonance structure (see FIG. 10).

An urethane sponge (thickness of 5 mm) was used as the windbreak member. In order to prevent the influence on the film vibration as much as possible, the double-sided tape was not used on the surface of the sponge on the film side, and a scotch tape was used on a part of the sponge on the air side surface (position on the lower portion of the sponge, which hits the frame portion of the film type resonance structure) to attach the sponge to the side wall portion of the film type resonance structure to prevent the sponge from deviating from the film type resonance structure.

<Measurement>

The fan of the produced fan silencing system was driven, and the sound volume was measured on the exhaust side and the intake side in the same manner as in Comparative Example 1.

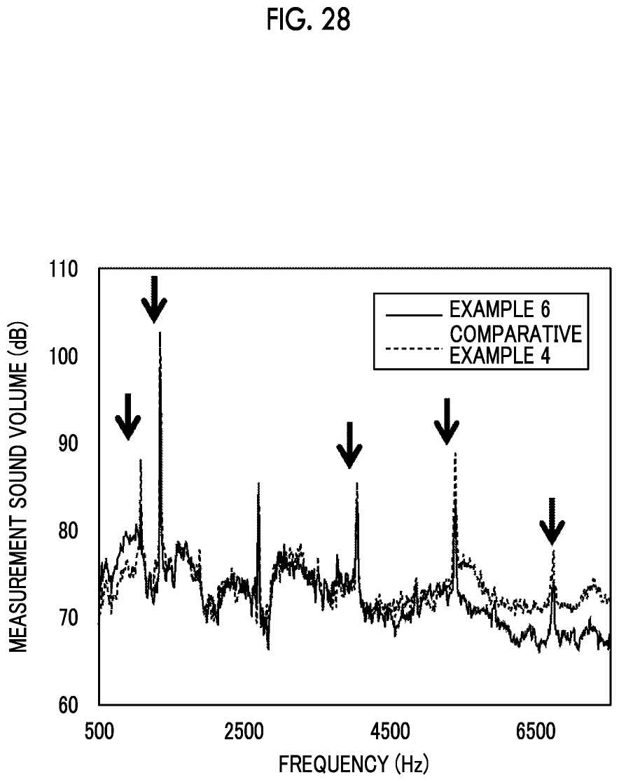

The measurement results on the exhaust side are shown in FIG. 28. In addition, the measurement results of Comparative Example 4 are also shown at the same time.

In addition, the wind speed at the outlet side end portion of Example 6 was measured by using the anemometer. As a result, it was confirmed that the wind speed was 14.5 m/s, and the wind speed was not changed.

From FIG. 28, it was found that the amplification of the sound around the resonance frequency (1.1 kHz), which occurred in Example 5, could be significantly suppressed. In addition, as shown by arrows in FIG. 28, it was found that the effect of reducing the peak sound of a frequency other than the resonance frequency could also be obtained. In addition, in FIG. 28, it was found that the sound could be silenced in a wide band in a high frequency region of 5.4 kHz or higher. The above is a sound absorption effect of the sponge disposed on the film surface.

From the above results, it was found that by disposing the windbreak member on the surface of the film, it was possible to significantly suppress the phenomenon that the sound was produced around the resonance frequency in a case in which the film type resonance structure was disposed in the very vicinity of the fan. In addition, it was found that by using the porous sound absorbing material as the windbreak member, both the silencing effect of the porous sound absorbing material and the silencing effect of the film type resonance structure could be achieved.

### Example 7

The fan silencing system was produced in the same manner as in Example 5 except that the Helmholtz resonance structure was used as the acoustic resonance structure.

In a case in which the Helmholtz resonance structure having a resonance frequency of 1.1 kHz was designed, a through-hole length was 3 mm, a through-hole diameter was 4 mm, an inner space thickness was 12 mm, and an inner space diameter was 24 mm.

The Helmholtz resonance structure was produced by processing an acrylic plate with the laser cutter to have such a configuration. The fan silencing system was produced in the same manner as in Example 5 such that the Helmholtz resonance structure 6 cells constituted a duct wall surface.

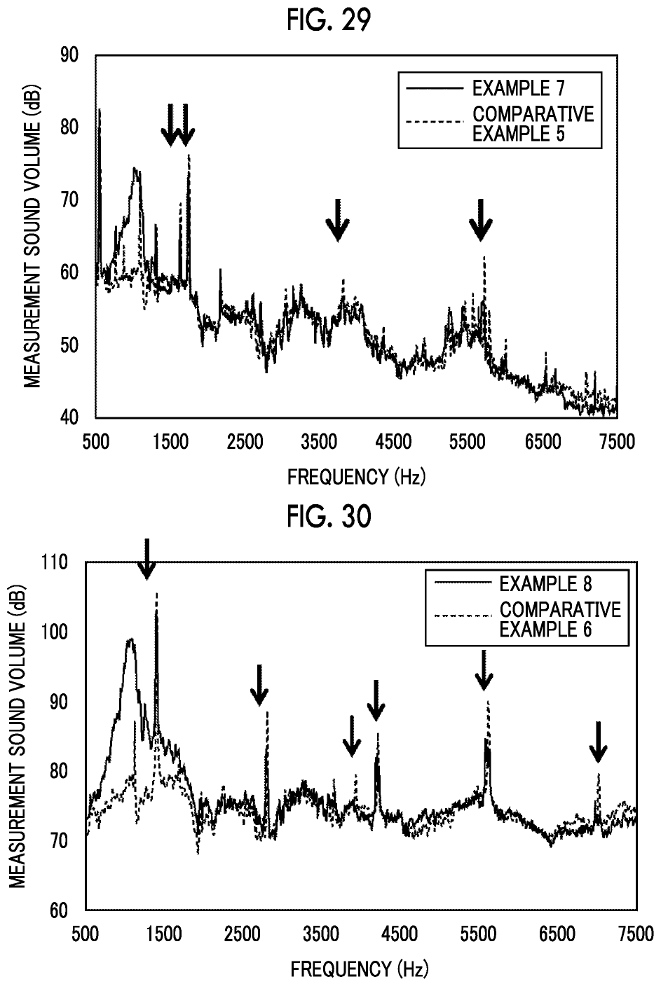

FIG. 29 shows the measurement results in a case in which the amount of current supplied to the fan is 0.3 A. In addition, the measurement results in a case in which the duct of the same length was attached instead of the Helmholtz resonance structure is also shown (Comparative Example 5). The wind speed at this time was 5.5 m/s.

From FIG. 29, it was found that even in a case in which the Helmholtz resonance structure was used as the acoustic resonance structure, the silencing effect for the peak sound at a frequency other than the resonance frequency could be obtained. On the other hand, the silencing volume at the peak of 1.1 kHz, which is the resonance frequency, was slight, and amplification of the sound occurred around the peak. The above is an effect that in the wind noise generated in the through-hole portion of the Helmholtz resonance structure, resonance occurred at the resonance frequency of the resonance structure the sound was amplified, and the sound was produced.

### Example 8

The sound volume was measured in the same manner as in Example 7 except that the amount of current supplied to the fan was 1.3 A. The measurement results are shown in FIG. 30. In addition, the measurement results in a case in which the duct of the same length was attached instead of the Helmholtz resonance structure is also shown (Comparative Example 6). In addition, the wind speed was 15.1 m/s.

From FIG. 30, it was found that the silencing effect of a plurality of peak sounds having frequencies other than the resonance frequency could also be obtained even in the Helmholtz resonance structure under a high air volume. On the other hand, it was found that the wind noise amplified by resonance was increased as the wind speed was increased, and the peak sound around the resonance frequency was amplified.

From the above, it was found that the silencing effect of the plurality of discrete frequency sounds by the resonance structure was not limited to the film type resonator, but is general. In addition, since the amplification effect of the Helmholtz resonance due to the wind noise had a larger amplification amount than the phenomenon in which the film type resonance structure sounds, it was considered that the film type resonance structure was desirable particularly in a case of being used in a strong wind.

### Comparative Example 7

In order to perform a study of the application to a fan other than the axial fan, a study of the application to the sirocco fan for a blower was performed. A blower 9BMC12P2G001 manufactured by SANYO DENKI CO., LTD. was used. A configuration was adopted in which the fan for the blower was disposed on anti-vibration rubber having a thickness of 10 mm, and the air taken in from the upper portion was discharged in the horizontal direction. An acrylic plate having a thickness of 5 mm with an opening (opening portion of about 30 mm×52 mm) of the same size as the blowing port was disposed, as a partition 102, at a position 30 mm spaced from the blowing port, and a microphone MP for measurement was disposed in a disposition in which the wind did not hit directly to perform an experiment. The wind speed measured at the opening portion of the partition 102 at this time was 7.7 m/s.

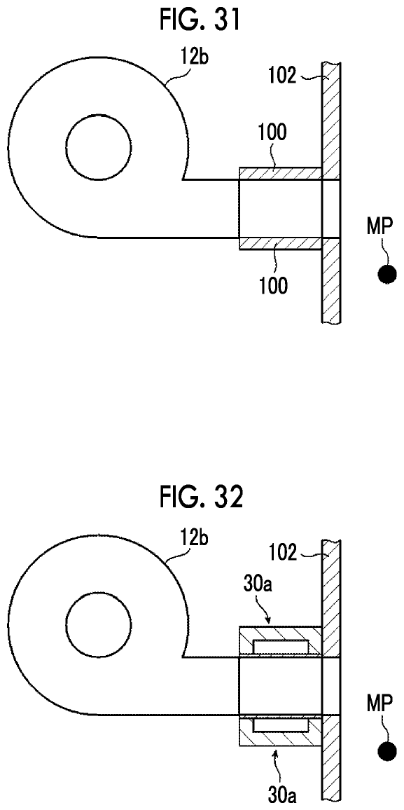

The measurement was performed in a state in which the blowing port and the opening portion of the partition 102 were connected by the duct 100 produced by an acrylic plate having a thickness of 5 mm. A schematic view is shown in FIG. 31.

### Example 9

The fan silencing system was produced in the same manner as in Comparative Example 7 except that four film type resonance structures 30a of Example 4 were disposed in a duct shape between the blowing port and the opening portion of the partition 102 (see FIG. 32).

A distance between the film type resonance structure 30a and the blade of the sirocco fan was 24 mm at minimum, and the film type resonance structure 30a was disposed in the near field region.

<Measurement>

In Example 9 and Comparative Example 7, the fan was driven and the sound volume was measured by the microphone MP for measurement.

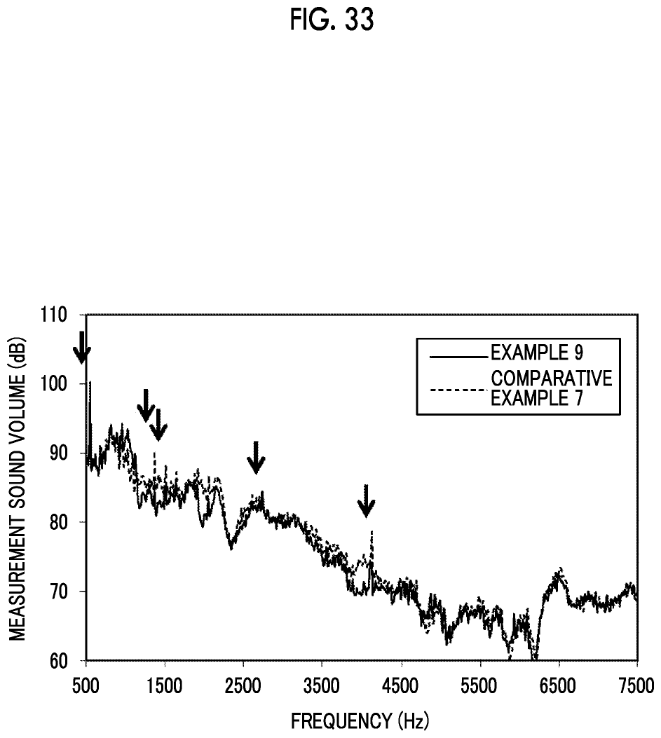

The measurement results are shown in FIG. 33.

From the results shown in FIG. 33, it was found that in a configuration of Example 9, the peak sound around the resonance frequency could be reduced and the silencing effect appeared for the peak sound of other frequencies. From this result, it was shown that even in a case of the sirocco fan, the silencing effect of the plurality of discrete frequency sounds could be obtained by disposing the acoustic resonance structure in the near field region as in a case of the axial fan.

From the results described above, the effect of the present invention is clear.

### EXPLANATION OF REFERENCES

10: fan silencing system
12a: axial fan
12b: sirocco fan
16: casing
16a: blowing port
18: rotor
20: shaft portion
22: blade
26: pipe line
30a, 30b: film type resonance structure
32, 42: frame
34: film
35: back space
36: anti-vibration member
38: blowing port
40: Helmholtz resonance structure
43: inner space
44: lid portion
46: through-hole
48: windbreak member
100: duct
102: partition
MP: microphone

What is claimed is:

1. A fan silencing system comprising:
a fan; and
an acoustic resonance structure,
wherein the acoustic resonance structure is disposed in a near field region of a sound generated by the fan.

2. The fan silencing system according to claim 1,
wherein a resonance frequency of the acoustic resonance structure coincides with at least one frequency of discrete frequency sounds caused by a rotation of a blade of the fan.

3. The fan silencing system according to claim 1,
wherein, as viewed from a direction perpendicular to a blowing port of the fan, an area in which the acoustic resonance structure overlaps with the blowing port is 50% or less of an area of the blowing port.

4. The fan silencing system according to claim 2,
wherein, as viewed from a direction perpendicular to a blowing port of the fan, an area in which the acoustic resonance structure overlaps with the blowing port is 50% or less of an area of the blowing port.

5. The fan silencing system according to claim 1,
wherein the acoustic resonance structure constitutes a part of a wall surface of a ventilation passage connected to the fan.

6. The fan silencing system according to claim 2,
wherein the acoustic resonance structure constitutes a part of a wall surface of a ventilation passage connected to the fan.

7. The fan silencing system according to claim 3,
wherein the acoustic resonance structure constitutes a part of a wall surface of a ventilation passage connected to the fan.

8. The fan silencing system according to claim 1,
wherein a surface provided with a vibrating body of the acoustic resonance structure is disposed in parallel to an axis perpendicular to a blowing port of the fan.

9. The fan silencing system according to claim 2,
wherein a surface provided with a vibrating body of the acoustic resonance structure is disposed in parallel to an axis perpendicular to a blowing port of the fan.

10. The fan silencing system according to claim 3,
wherein a surface provided with a vibrating body of the acoustic resonance structure is disposed in parallel to an axis perpendicular to the blowing port of the fan.

11. The fan silencing system according to claim 4,
wherein a surface provided with a vibrating body of the acoustic resonance structure is disposed in parallel to an axis perpendicular to the blowing port of the fan.

12. The fan silencing system according to claim 1, further comprising:
a windbreak member that transmits a sound to a surface side provided with a vibrating body of the acoustic resonance structure.

13. The fan silencing system according to claim 1,
wherein the acoustic resonance structure is in contact with the fan.

14. The fan silencing system according to claim 13,
wherein the acoustic resonance structure is in contact with the fan via an anti-vibration member.

15. The fan silencing system according to claim 1,
wherein a plurality of the acoustic resonance structures having different resonance frequencies are provided, and
the acoustic resonance structure having a high resonance frequency is disposed at a position closer to the fan than the acoustic resonance structure having a low resonance frequency.

16. The fan silencing system according to claim 1,
wherein the acoustic resonance structure is disposed only on a downstream side of the fan in a blowing direction of the fan.

17. The fan silencing system according to claim 1,
wherein the acoustic resonance structure is disposed on an upstream side and a downstream side of the fan in a blowing direction of the fan.

18. The fan silencing system according to claim 1,
wherein the acoustic resonance structure is a film type resonance structure including a film having a fixed peripheral portion and supported to allow a film vibration, and a back space formed on one surface side of the film.

19. The fan silencing system according to claim 18,
wherein the film type resonance structure has a through-hole that communicates the back space with an outside.

20. The fan silencing system according to claim 1,
wherein the fan is an axial fan.
